(19) United States
(12) Patent Application Publication
(10) Pub. No.: US 2020/0169336 A1
(43) Pub. Date: May 28, 2020

(54) Apparatuses and Methods for Positioning

(71) Applicant: Telefonaktiebolaget LM Ericsson (publ), Stockholm (SE)

(72) Inventors: Sara Modarres Razavi, Linköping (SE); Fredrik Gunnarsson, Linköping (SE); Henrik Rydén, Solna (SE); Iana Siomina, Täby (SE)

(21) Appl. No.: 16/318,508

(22) PCT Filed: Nov. 26, 2018
(86) PCT No.: PCT/SE2018/051213

§ 371 Date: Jan. 17, 2019

(51) Int. Cl. H04B 17/27; G01S 5/14; G01S 5/02

(52) U.S. Cl. CPC H04B 17/27; G01S 5/0236; G01S 5/14

(57) ABSTRACT

The present disclosure relates to radio network communication. In one of its aspects, the disclosure presented herein concerns a method for performing beam-based positioning. The method is implemented in a target device. According to the method, a list of transmitter beam IDentities (IDs) accompanied with corresponding beam-based Positioning Reference Signal (PRS) configurations for one or more radio cells associated with one or more radio network nodes are received. Different beam-based PRS sequences are used for different transmitter beams of one radio network node. Based on the received list of transmitter beam IDs accompanied with corresponding PRS configurations, a set of transmitter beams for subsequent measuring are determined. Beam-based PRSs associated with the determined set of transmitter beams are received from at least one radio network node, beam-based PRSs associated with the determined set of transmitter beams and Time Of Arrival (TOA) of the beam-based PRSs associated with the determined set of transmitter beams are measured.

### TECHNICAL FIELD

The present disclosure generally relates to telecommunications. In particular, the various embodiments described in this disclosure relates to apparatuses and methods for performing beam-based positioning.

### BACKGROUND

This section is intended to provide a background to the various embodiments of the invention that are described in this disclosure. Therefore, unless otherwise indicated herein, what is described in this section should not be interpreted to be prior art by its mere inclusion in this section.

Mobile positioning is an important area for emergency and is used to attain a current position of a target device, such as a User Equipment (UE), which is either stationary or moving. In the legacy Long Term Evolution (LTE) standards, there is a positioning node that calculates the network-based location determination of UEs. This positioning node is typically referred to as Evolved Serving Mobile Location Center (E-SMLC). The E-SMLC calculates the final location and estimates velocity as well as the location accuracy of the UEs. In the legacy LTE standards, the following LTE-based positioning techniques are supported:
Enhanced Cell Identity (ID). Essentially cell ID information to associate the target device to the serving area of a serving cell, and then additional information to determine a finer granularity position.
Assisted Global Navigation Satellite System (GNSS). GNSS information retrieved by the target device, supported by assistance information provided to the target device from E-SMLC.
Observed Time Difference of Arrival (OTDOA). The target device estimates the time difference of reference signals from different base stations and sends to the E-SMLC for multilateration.
Uplink TDOA (UTDOA). The target device is requested to transmit a specific waveform that is detected by multiple location measurement units, e.g. an eNB, at known positions. These measurements are forwarded to E-SMLC for multilateration

In LTE, the basic concept of OTDOA is that a positioning server, e.g. the E-SMLC, requests the position of a target device, e.g. a UE. This triggers the UE to estimate time of arrival (TOA) of signals received from multiple base stations, e.g. eNBs. The TOAs from several neighboring eNBs are subtracted from a TOA for a reference cell to form OTDOAs that the UE reports to the network. These measurements are known as Reference Signal Time Difference (RSTD) measurements. Based on the reported RSTD measurements and known positions of the involved eNBs, the positioning server can estimate the position of the UE by using multilateration techniques. Positioning Reference Signals (PRS) are the main OTDOA's reference signal used in an LTE network.

A PRS sequence is defined such that it can cover the maximum LTE bandwidth that has N_{RB}^{max,DL} Physical Resource Blocks (PRBs). In legacy LTE, with N_{RB}^{PRS} PRBs configured for positioning, a subsequence of 2·N_{RB}^{PRS} elements (m=0,1, . . . , 2·N_{RB}^{PRS}−1) is obtained from truncating the reference-signal sequence to obtain r_{l,n}_{ₛ}(m′), where m′=m+N_{RB}^{max,DL}−N_{RB}^{PRS}. This mapping is illustrated in FIG. 1. As illustrated in FIG. 1, the used PRS sequence is the center part of the whole reference-signal sequence defined for N_{RB}^{max,DL}=110 PRBs.

The legacy LTE (Rel-9) PRS mapping pattern is shown in FIG. 2. As illustrated in FIG. 2, the pattern is a diagonal pattern mapped to all Orthogonal Frequency Division Multiplexing (OFDM) symbols except OFDM symbols falling in potential Physical Downlink Control Channel (PDCCH) region, i.e. the first 3 OFDM symbols in a subframe, and OFDM symbols that may be used by Cell-Specific Reference Signal (CRS). FIG. 2 also shows an example shift in frequency domain. The shift in the mapping is a function of cell ID: v_{shift}=N_{ID}^{cell} mod 6 which yields a total of 6 possible frequency shifts.

Positioning in New Radio (NR) is to be supported by the architecture shown in FIG. 3. Location Management Function (LMF) is the location server in NR. There are also interactions between the location server and a radio network node, e.g. a gNodeB, via the NR Positioning Protocol A (NRPPa) protocol. The interactions between the radio network node and a target device, e.g. a UE, is supported via the Radio Resource Control (RRC) protocol. The location server may further be communicatively coupled to a Gateway Mobile Location Center (GMLC) and an Access and Mobility Management Function (AMF). The LMF may be communicatively coupled to the GMLC and AMF via NGLs, and the GMLC may be communicatively coupled to the AMF via NGLg.

In both LTE and New Radio (NR) communication systems multiple-antennas may be used. At high frequencies, antenna elements generally get smaller, making it possible to use a large number of antenna elements without making the antenna size prohibitively large. By spreading total transmission power wisely over the multiple antennas, an array gain can be achieved which increases signal quality. The transmitted signal from each antenna is formed in such way that the received signal from each antenna adds up coherently at a receiver, e.g. at a target device such as a UE. This is referred to as beam-forming or transmitter beam-forming. In order to form a “beam” from the multiple antennas, precoding is used. The precoding describes how to form each antenna in the antenna array in order to form the “beam”.

NR features a highly flexible but unified Channel State Information (CSI) framework, in which there is reduced coupling between CSI measurement, CSI reporting and the actual Down Link (DL) transmission compared with LTE. The CSI framework may be seen as a toolbox, where different CSI reporting settings and Channel State Information-Reference Signal (CSI-RS) resource settings for channel and interference measurements can be mixed and matched so they correspond to the antenna deployment and transmission scheme in use. The CSI reports on different beams can be dynamically triggered. The framework also supports more advanced schemes such as multi-point transmission and coordination. The control and data transmissions, in turn, follow the self-contained principle, where all information required to decode the transmission, such as accompanying DeModulation Reference Signal (DMRS), is comprised within the transmission itself. As a result, the network can seamlessly change the transmission point or beam as the target device moves in the network.

In 5G, Base Stations (BSs) can do narrow beamforming when equipped with many antennas. To get the best possible beam for a target device, such as a UE, the CSI-RS framework may be used. The UE measures on a set of CSI-RS transmission and selects the best beam. The CSI-RS needs a time and/or frequency synch reference which could be provided by the Synchronization Signal (SS). However, in configurations where SS is transmitted via relatively wide, low gain beams and there is a desire to configure narrow, high gain beams associated for CSI-RS transmission, it can be difficult to rely on SS for synchronization. An alternative is to consider a separate reference signal for time and/or frequency synchronization—a signal that is not always transmitted, but possibly on a need basis. One such signal is Tracking Reference Signal (TRS). Generally, the assumption is that the TRS should be transmitted using a narrower beam than SS to enable higher directional gains. TRS may also be characterized by a different bandwidth and/or signal Resource Element (RE) density (in time and frequency) configurations. The TRS concept in New Radio (NR) is illustrated in FIG. 4.

An important function in wireless communication systems using a large number of antenna elements is beam management. The beam management may involve beam-specific measurements, e.g. based on CSI-RS or Synchronization Signal Block (SSB), and best beam selection, etc. SSB based beam management may comprise SSB identification within a SS burst set, meaning that the UE by using the time index identifies the SSB and selects the best SSB time index, which can be considered as the concept of beam sweeping and management shown in FIG. 5.

The current available positioning methods in LTE may provide positioning accuracy to support the emergency call use case in 5G. However, current architecture and configurations are not capable of fulfilling higher accuracy positioning demands in 5G positioning. Higher accuracy positioning is required in 5G, i.e. sub-meter level, especially to furnish the use cases for critical machine type communication, Ultra-Reliable Low Latency Communication (URLLC). Therefore, while the emergency call use case was the main application for positioning development in cellular networks, the massive and critical Machine Type Communication (MTC) now seems to be a greater force for the enhancements in positioning topic, in addition to the emergency positioning.

### SUMMARY

It is in view of the above background and other considerations that the various embodiments of the present disclosure have been made.

Higher accuracy positioning is one exemplary demanding factor in 5G. Furthermore, aside from the positioning accuracy, existing solutions for positioning have lots of overhead for the network, and the Positioning Reference Signals (PRS) is statically configured and does not change with the change in user behavior or location in the network. An additional challenge with LTE PRS is the interference from PRSs from neighboring cells, which led to the introduction of a muting framework, where cells take turn transmitting PRSs.

In view of the above, it is therefore a general object of the aspects and embodiments described throughout this disclosure to provide a solution to address at least some of these problems by defining a target device specific beam-based PRS and to enable selection of narrow beams in neighbor cells to improve the positioning accuracy and reduce the network overhead.

This general object has been addressed by the appended independent claims. Advantageous embodiments are defined in the appended dependent claims.

According to a first aspect, there is provided a method for performing beam-based positioning. The method is implemented in a target device.

The method comprises receiving, from a location server, a list of transmitter beam IDentities (IDs) accompanied with corresponding beam-based PRS configurations for one or more radio cells associated with one or more radio network nodes. Different beam-based PRS sequences are used for different transmitter beams of one radio network node. The method further comprises determining, based on the received list of transmitter beam IDs accompanied with corresponding PRS configurations, a set of transmitter beams for subsequent measuring. Thereafter, beam-based PRSs associated with the determined set of transmitter beams are received from at least one radio network node and Time Of Arrival (TOA) of the beam-based PRSs associated with the determined set of transmitter beams are measured.

In one embodiment, the method further comprises combining, based on the received list of transmitter beam IDs accompanied with corresponding PRS configurations, two or more of the measured TOAs into one TOA.

In one embodiment, the method further comprises transmitting, to the location server, a report based on the measured TOAs of the beam-based PRSs. Additionally or alternatively, the method further comprises transmitting, to at least one radio network node, a report based on the measured TOAs of the beam-based PRSs.

In one embodiment, the method further comprises receiving, from the location server, a capability request associated with positioning to indicate type of capabilities associated with beam-based measurements supported by the target device. In response thereto the method further comprises transmitting, to the location server, a capability response indicating measurement configurations supported by the target device in relation to beam-based measurements.

In one embodiment, the step of determining a set of transmitter beams for subsequent measuring further comprises determining resources associated with the transmitter beams during which beam-based PRS may be transmitted via corresponding transmitter beams.

In one embodiment, the method further comprises determining at least one radio signal sequence associated with a transmitter beam to be used for a positioning measurement and determining the numerology of the signal.

In one embodiment, the method further comprises determining, and configuring, a receiver beam ID to receive the beam-based PRS associated with a corresponding transmitter beam ID.

In one embodiment, the method further comprises performing self-localization based on the measured TOAs of the beam-based PRSs and known positions of the radio network nodes transmitting the corresponding beam-based PRSs, by using multilateral techniques.

In a second aspect, the present disclosure provides a target device configured to performing beam-based positioning.

The target device comprises a processing circuitry and a memory circuitry. The memory circuitry stores computer program code which, when run in the processing circuitry, causes the target device to receive, from a location server, a list of transmitter beam IDs accompanied with corresponding beam-based PRS configurations for one or more radio cells associated with one or more radio network nodes. Different beam-based PRS sequences are used for different beams of one radio network node. The target is further caused to determine, based on the received list of transmitter beam IDs accompanied with corresponding PRS configurations, a set of transmitter beams for subsequent measuring. Thereafter the target device is caused to receive, from at least one radio network node, beam-based PRS associated with the determined set of transmitter beams and to measure TOA of the beam-based associated with the determined set of transmitter beams.

In one embodiment, the memory circuitry storing computer program code which, when run in the processing circuitry, causes the target device to combine, based on the received list of transmitter beam IDs accompanied with corresponding PRS configurations, two or more of the measured TOAs into one TOA.

In one embodiment, the memory circuitry storing computer program code which, when run in the processing circuitry, causes the target device to transmit, to the location server, a report based on the measured TOAs of the beam-based PRSs.

In one embodiment, the memory circuitry storing computer program code which, when run in the processing circuitry, causes the target device to transmit, to at least one radio network node, a report based on the measured TOAs of the beam-based PRSs.

In one embodiment, the memory circuitry storing computer program code which, when run in the processing circuitry, further causes the target device to receive, from the location server, a capability request associated with positioning to indicate type of capabilities associated with beam-based measurements supported by the target device. In response thereto, the target device is caused to transmit, to the location server, a capability response indicating measurement configurations supported by the target device in relation to beam-based measurements.

In one embodiment, the memory circuitry storing computer program code which, when run in the processing circuitry, further causes the target device to determine a set of transmitter beams for subsequent measuring by determine resources associated with the transmitter beams during which beam-based PRS may be transmitted via corresponding beams.

In one embodiment, the memory circuitry storing computer program code which, when run in the processing circuitry, further causes the target device to determine at least one radio signal sequence associated with a transmitter beam to be used for a positioning measurement and determine the numerology of the signal.

In one embodiment, the memory circuitry storing computer program code which, when run in the processing circuitry, further causes the target device to determine, and configure, a receiver beam ID to receive the beam-based PRS associated with a corresponding transmitter beam ID.

In one embodiment, the memory circuitry storing computer program code which, when run in the processing circuitry, further causes the target device to perform self-localization based on the measured TOAs of the beam-based PRSs and known positions of the radio network nodes transmitting the corresponding beam-based PRSs, by using multilateral techniques.

According to a third aspect, the disclosure provides a method, implemented in a location server for performing beam-based positioning.

The method comprising determining, based on a Beam Reference Signal (BRS) Received Power (RP) report from a target device, a list of transmitter beam IDs for one or more radio cells associated with one or more radio network nodes and determining resources for beam-based PRS for each radio network node based on the radio network nodes common and beam specific parameters. The method further comprises the step of transmitting, to the target device, a list of transmitter beam IDs, accompanied with corresponding beam-based PRS configurations for the one or more radio cells associated with one or more radio network nodes, wherein different beam-based PRS sequences are used for different transmitter beams of one radio network node.

In one embodiment, the method further comprises transmitting resources for beam-based PRS to each of the radio network nodes.

In one embodiment, the method further comprises transmitting, to the target device, a capability request associated with positioning to indicate type of capabilities associated with beam-based measurements supported by the target device. The method further comprises receiving, from the target device, a capability response indicating measurement configurations supported by the target device in relation to beam-based measurements.

In one embodiment, the method further comprises transmitting, to each radio network node, a request for the radio network node's common parameters; and receiving, from each radio network node, common parameters.

In one embodiment, the method further comprises receiving, from the target device, a report based on measured TOAs of the beam-based PRSs The method further comprises computing a position of the target device, based on the received report and known positions of the radio network nodes transmitting the corresponding beam-based PRSs, by using multilateral techniques.

According to a fourth aspect, the disclosure provides a location server configured to performing beam-based positioning.

The location server comprises a processing circuitry and a memory circuitry. The memory circuitry storing computer program code which, when run in the processing circuitry, causes the location server to determine, based on a BRSRP report from a target device, a list of transmitter beam IDs for one or more radio cells associated with one or more radio network nodes. The location server is further caused to determine resources for beam-based PRS for each radio network node based on the radio network nodes common and beam specific parameters and to transmit, to the target device, a list of transmitter beam IDs accompanied with corresponding beam-based PRS configurations for the one or more radio cells associated with one or more radio network nodes. Different beam-based PRS sequences are used for different beams of one radio network node.

In one embodiment, the memory circuitry storing computer program code which, when run in the processing circuitry, further causes the location server to transmit resources for beam-based PRS to each of the radio network nodes.

In one embodiment, the memory circuitry storing computer program code which, when run in the processing circuitry, further causes the location server to transmit, to the target device, a capability request associated with positioning to indicate type of capabilities associated with beam-based measurements supported by the target device; and to receive, from the target device, a capability response indicating measurement configurations supported by the target device in relation to beam-based measurements.

In one embodiment, the memory circuitry storing computer program code which, when run in the processing circuitry, further causes the location server to transmit, to each radio network node, a request for the radio network node's common parameters; and to receive, from each radio network node, common parameters.

In one embodiment, the memory circuitry storing computer program code which, when run in the processing circuitry, further causes the location server to receive, from the target device, a report based on measured TOAs of the beam-based PRSs; and to compute a position of the target device, based on the received report and known positions of the radio network nodes transmitting the corresponding beam-based PRSs, by using multilateral techniques.

According to a fifth aspect, the disclosure provides a method, implemented in a radio network node, for performing beam-based positioning.

The method comprises transmitting, to a target device, beam-based PRS, wherein different beam-based PRS sequences are used for different transmitter beams of the radio network node.

In one embodiment, the method further comprises receiving, from a location server, resources for beam-based PRS.

In one embodiment, the method further comprises receiving, from the location server, a request for common parameters; and transmitting, to the location server, common parameters.

In one embodiment, the method further comprises receiving, from a target device, a report based on measured TOAs of the beam-based PRSs; and computing a position of the target device, based on the received report and known positions of the radio network nodes transmitting the corresponding beam-based PRSs, by using multilateral techniques.

According to a sixth aspect, the disclosure provides a radio network node configured to performing beam-based positioning.

The radio network node comprises a processing circuitry and a memory circuit. The memory circuitry storing computer program code which, when run in the processing circuitry, causes the radio network node to transmit, to a target device, beam-based PRS. Different beam-based PRS sequences are used for different transmitter beams of the radio network node (600).

In one embodiment, the memory circuitry storing computer program code which, when run in the processing circuitry, further causes the radio network node to receive, from a location server, resources for beam-based PRS.

In one embodiment, the memory circuitry storing computer program code which, when run in the processing circuitry, further causes the radio network node to receive, from the location server, a request for common parameters and transmit, to the location server, common parameters.

In one embodiment, the memory circuitry storing computer program code which, when run in the processing circuitry, further causes the radio network node to receive, from a target device, a report, based on measured TOAs of the beam-based PRSs; and compute a position of the target device based on the received report and known positions of the radio network nodes transmitting the corresponding beam-based PRSs, by using multilateral techniques.

According to a seventh aspect, there is provided a computer program, comprising instructions which, when executed on a processing circuitry, cause the processing circuitry to carry out the method according to any one of the first aspect and/or the third aspect and/or the fifth aspect.

According to an eight aspect, the disclosure provides a carrier containing the computer program of the seventh aspect, wherein the carrier is one of an electronic signal, optical signal, radio signal, or computer readable storage medium.

The various proposed embodiments herein provide a framework for selecting transmitter beams of a transmitting node at a receiving node to receive radio signals for positioning purpose and also a framework for reporting the measurements performed on these beams for positioning in 5G networks. Accordingly, the various proposed embodiments herein may allow to use a target device specific PRS signal which will avoid the overhead and interference from unnecessary reference signal transmission, while ensuring good reachability. The beam-based PRS may use beam-level identity for sequence generation and may provide more accurate positioning as it deals with smaller granularity in comparison to previous solutions. By having different beam-based PRS sequence for different beams of one radio network node, the cell-based PRS transmission constraint may be relaxed.

Furthermore, the present disclosure may ensure that the target device receives signals from more a sufficient amount of locations, which may be necessary, e.g. for OTDOA. Additionally or alternatively, the present disclosure may ensure that the network node is receiving, at different locations via narrow beams, a transmission from the target device, e.g., for UTDOA.

### BRIEF DESCRIPTION OF THE DRAWINGS

These and other aspects, features and advantages will be apparent and elucidated from the following description of various embodiments, reference being made to the accompanying drawings, wherein:

FIG. 1 illustrates a LTE PRS sequence truncation;

FIG. 2 illustrates LTE PRS mapping;

FIG. 3 shows NR positioning architecture;

FIG. 4 illustrates the TRS concept in NR;

FIG. 5 shows beam sweeping and management;

FIG. 6 is a message sequence chart of a process for performing beam-based positioning according to an example embodiment;

FIG. 7 is a flowchart of an example method performed by a target device;

FIG. 8 shows an example implementation of a target device;

FIG. 9 is a flowchart of an example method performed by a location server;

FIG. 10 shows an example implementation of a location server;

FIG. 11 is a flowchart of an example method performed by a radio network node;

FIG. 12 shows an example implementation of a radio network node;

FIG. 13 illustrates an example wireless network;

FIG. 14 shows a user equipment according to an embodiment;

FIG. 15 shows a virtualization environment according to an embodiment;

FIG. 16 illustrates an example telecommunication network connected via an intermediate network to a host computer;

FIG. 17 shows a host computer communicating via a base station with a user equipment over a partially wireless connection according to an embodiment;

FIG. 18 shows an example method implemented in a communication system including a host computer, a base station and a user equipment;

FIG. 19 illustrates an example method implemented in a communication system including a host computer, a base station and a user equipment;

FIG. 20 shows an example method implemented in a communication system including a host computer, a base station and a user equipment;

FIG. 21 illustrates an example method implemented in a communication system including a host computer, a base station and a user equipment;

FIG. 22 shows an example method; and

FIG. 23 illustrates a virtualization apparatus according to some embodiments.

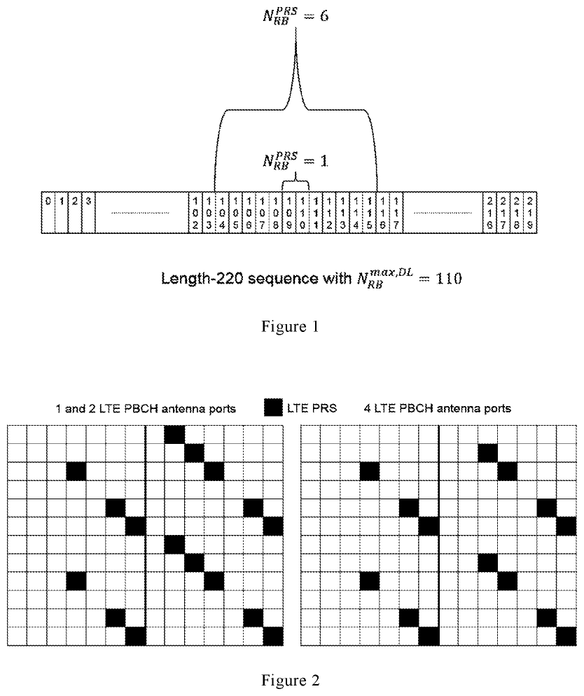

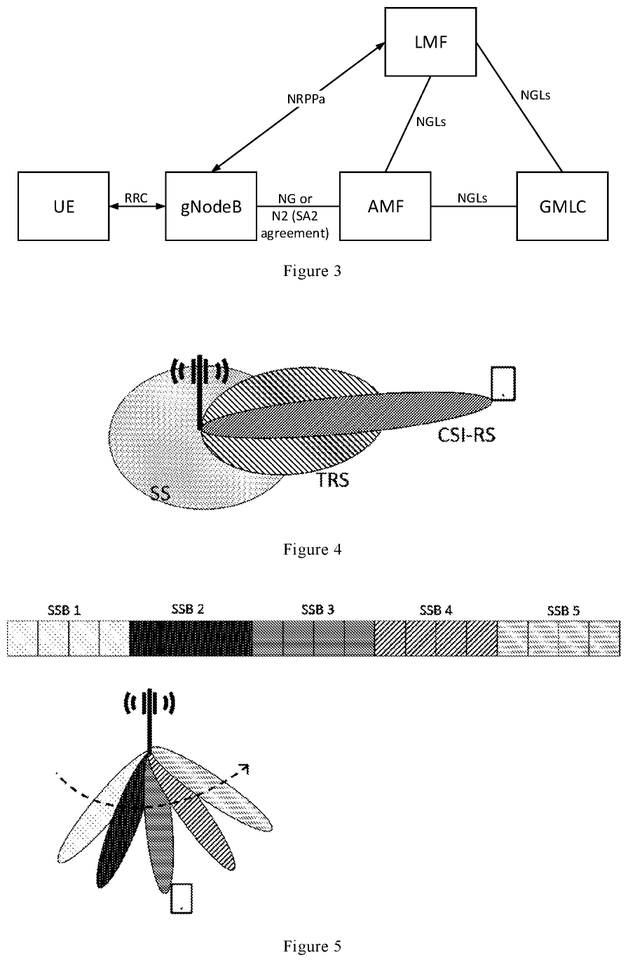

### DETAILED DESCRIPTION

The present invention will now be described more fully hereinafter. The present invention may, however, be embodied in many different forms and should not be construed as limited to the embodiments set forth herein; rather, these embodiments are provided by way of example so that this disclosure will be thorough and complete, and will fully convey the scope of the invention to those persons skilled in the relevant art. Like reference numbers refer to like elements throughout the description.

The benefit of a narrow beam is a more granular angular estimation and higher beamforming gain. Narrow beams may also be beneficial in scenarios with good Line Of Sight (LOS). According to the disclosure, a beam may refer to a configuration of one or more antennas or antenna elements enabling a transmission and/or reception in a narrow direction. For example, a signal can be transmitted via one or more beams, in different directions, at the same or different times e.g. with digital, analogue, or hybrid beamforming, in the same cell from the same location so that different one or subsets of beams in the cell are received at different locations.

In one of its aspects, the disclosure presented herein concerns a method for performing beam-based positioning.

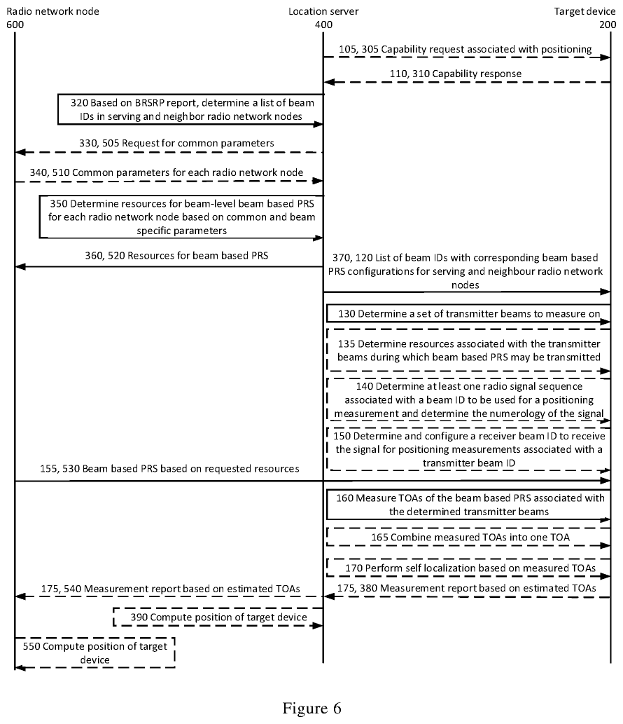

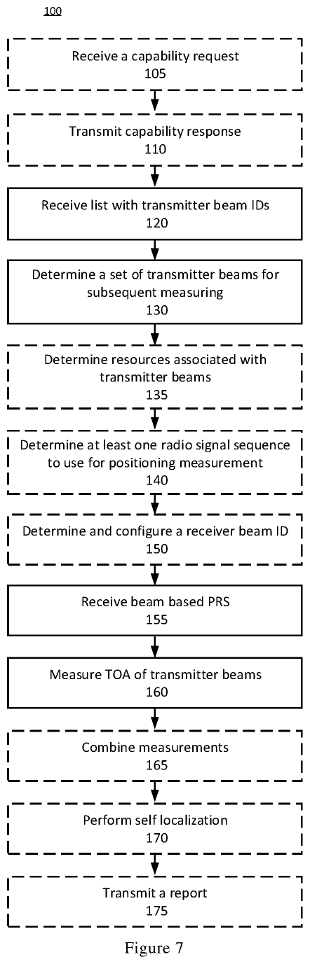

With reference to the FIGS. 6 and 7, a first embodiment will now be described. FIG. 6 illustrates a message sequence chart of a process for performing beam-based positioning, illustrating which messages and information that is sent between different entities in a network communications system. FIG. 7 illustrates a method 100, implemented in a target device such as e.g. a User Equipment (UE), for performing beam-based positioning.

The method 100 starts at step 120 with the target device receiving, from a location server, a list of transmitter beam IDentities (IDs) accompanied with corresponding beam-based Positioning Reference Signal (PRS) configurations for one or more radio cells associated with one or more radio network nodes. Different beam-based PRS sequences are used for different transmitter beams of one radio network node. Since different beams may not be transmitted at the same time like SS blocks, the selection of beams is communicated via the location server.

The list received by the terminal may, for example, include transmitter beam IDs accompanied with corresponding beam-based PRS configurations associated with one radio network node. Alternatively, the terminal may, for example, receive a list of transmitter beam IDs accompanied with corresponding beam-based PRS configurations for a plurality of radio cells associated with a plurality of radio network nodes. One of the cells that is included in the list may, according to one example, be associated with the serving radio network node. According to this example, radio network nodes that are associated with the other beam IDs included in the list may be neighbouring radio network nodes.

The number of transmitter beam IDs accompanied with corresponding PRS configurations received in the list in step 120, may depend on current conditions. For example, if the beams are narrow the target device may be provided with more beam options in order to ensure that the target device may have more choices. This as the probability of receiving a sufficient number of transmitter beams may decrease with the narrower beams. Furthermore, the location server may also account for co-located and/or not co-located beams.

At step 130, a set of transmitter beams for subsequent measuring is determined based on the received list of transmitter beam IDs accompanied with corresponding PRS configurations. At step 155, beam-based PRSs associated with the determined set of transmitter beams are received from at least one radio network node. Thereafter, at step 160, Time Of Arrival (TOA) of the beam-based PRSs associated with the determined set of transmitter beams are measured.

The proposed method defines beam-based PRS such that beam-level identity is used for sequence generation by having different beam-based PRS sequences for different beams of one radio network node. The method may ensure that the target device receives signals from as many locations as are necessary. In some embodiments, the number of locations may preferably be more than five, e.g. for OTDOA, when narrow beams are transmitted from neighboring cells. Accordingly, the proposed method defines a target device specific beam-based PRS and also enables selection of narrow beams in neighbouring cells, which improves the positioning accuracy and reduce the network overhead for NR.

The beams used for beam-based PRS may be characterized by two sets of parameters: common cell parameters and beam specific parameters. The common cell parameters may, for example, comprise frequency band and frequency, e.g. Evolved-Universal Terrestrial Radio Access (E-UTRA) Absolute Radio Frequency Channel Number (EARFCN), system bandwidth, e.g. cell bandwidth, cell reference time, e.g. System Frame Number 0 (SFN0) and cell-level ID, e.g. Physical Cell Id (PCI). Beam-specific parameters may, for example, comprise beam level ID, scrambling code for the beam transmissions, beamwidth, direction, target device measurement bandwidth or transmission bandwidth of a beam-specific signal, time and/or frequency resources for beam-specific transmissions, time offset between a reference time and the time-frequency resources of the beam-specific transmissions.

In one embodiment, the method may further comprise combining 165 two or more of the measured TOAs into one TOA. The combining of the measured TOAs may be based on the received list of transmitter beam IDs accompanied with corresponding PRS configurations. For example, in case of a wider TRS -like beam is used, the target device may combine the measured TOAs associated with the wide beam into one TOA measurement. By combining the two or more of the measured TOAs into one TOA, the amount of subsequent signalling may be reduced. The information of where and how the target device should measure beam-based PRS may, for example, be received from the location server, e.g. in step 120.

Furthermore, some wide beams may be configured with more than one beam-based PRS sequence, for example, if the number of resources may not be sufficient for one beam given the constraints of the beam-based PRS sequence and mapping generation, the location server may then indicate that two beams may be coherently combined at the target device.

When one radio network node is transmitting multiple beam-based PRS beams, the location server may indicate, e.g. in step 120, the radio network node ID and that the target device may combine the result for each beam into one TOA measurement. In one embodiment, the radio network nodes may signal the time indices of the SSBs with beam-based PRS, corresponding to the beam IDs, that may be combined into one TOA value.

In one embodiment, the target device may get an indication, together with the received information at step 120, i.e. in the assistance information, that this is a beam-based PRS configuration which the target device may have to take a first set of actions. If no indication is received, the target device may take a second set of actions, e.g. legacy-like, without beams.

In one embodiment, the method may further comprise transmitting 175, to the location server, a report based on the measured TOAs of the beam-based PRSs. As the report is based on the measured TOAs of the beam-based PRSs. This means that the report, in some embodiments, may also comprise the measured TOAs of the beam-based PRSs. The information comprised in the report may, in accordance with one embodiment, depend on the received assistance information in step 120. For example, in one embodiment, the target device may include signal quality of the one or more beams used to measure TOA for each node.

To enable an accurate Angle Of Arrival (AOA) to the target device, the target device may also report the beam ID corresponding to the beam used to estimate the TOA. In case of using multiple beams to form one TOA, the target device may report the indices for all the used beams. The target device may, for example, report one TOA for each location and/or node, if the location server has indicated what node each beam is transmitted from. In one embodiment, the method may further comprise, additionally or alternatively, transmitting 175, to at least one radio network node, the report based on the measured TOAs of the beam-based PRSs. The report may, for example, be transmitted to the serving radio network node.

Based on measured TOA for each radio network node, or for each beam, or for each set of wide beams, the target device may form Reference Signal Time Difference (RSTD) measurements and may also transmit these to the location server and/or at least one radio network node.

In one embodiment, the method may further comprise receiving 105, from the location server, a capability request associated with positioning. The capability request is to indicate type of capabilities associated with beam-based measurements that are supported by the target device. In response thereto, the target device may transmit 110, to the location server, a capability response indicating measurement configurations supported by the target device in relation to beam-based measurements. The capability associated with positioning may comprise a target device's ability to support, for example, receiving beam-specific beam-based PRS, the target device's ability to receive beam-based PRS simultaneously with other signals transmitted via a different beam and/or from a different location, the target device's ability to receive beam based PRS in specific one or more numerologies or subcarrier spacings, the target device's ability to receive NR-PRS in a numerology different from the numerology of other signals/channel being received such as other reference signals, control channel, or data, the maximum number of beams the target device is able to measure for positioning, e.g., in total and/or per carrier and/or per cell, which may be different from the number of beams for Radio Resource Management (RRM) measurements, smallest and/or largest receiver beam width supported by the target device for positioning, etc. By providing a capability response to the radio network node, it may be assured, that target device may only receive measurement configurations that are supported by the target device.

The target device may at step determine 130, based on the received list of transmitter beam IDs accompanied with corresponding PRS configurations, a set of transmitter beams for subsequent measuring. The set may be explicitly provided by a radio network node or determined by the target device by selecting from a larger set of beams provided by a network node. In one embodiment, the step of determining 130 a set of transmitter beams for subsequent measuring may further comprises determining 135 resources associated with the transmitter beams during which beam-based PRS may be transmitted via corresponding transmitter beams.

In some embodiments, after determining 130 the set of beams, the method may further comprises the step of determining 140 at least one radio signal sequence associated with a transmitter beam to be used for a positioning measurement and determining the numerology of the signal. The numerology, e.g. SubCarrier Spacing (SPC), etc., may be used to configure the target device to correctly sample the signal. In LTE, there was only one pre-defined SCS, while in NR the target device may have to adapt the receiver configuration to the SCS. In one example, the numerology may be provided by the network. In another example, it may be determined based on a pre-defined rule or via association, e.g. the same numerology as a known signal of the serving cell.

In some embodiments, the method may further comprise the step of determining 150, and configuring, a receiver beam ID to receive the beam-based PRS associated with a corresponding transmitter beam ID. Accordingly, the target device receiver beam may match and/or correspond to the radio network node's transmitter beam. Different receiver beams may be configured to receive signals from different locations or even from the same location but transmitted via different beams.

In addition to the step 150 of determining, and configuring, a receiver beam ID, the method may according to some embodiments determining the receiver beam to be used by receiver beam sweeping and selecting the best receiver beam to receive beam-based PRS via a radio network node's transmitter beam. Configuring a receiver beam, or performing receive beamforming, may further comprise configuring a wider beam to receiver beam-based PRS and a narrower beam to receive signals for RRM operation, e.g., cell identification, RRM measurement, etc. The target device may further indicate, explicitly or implicitly, a receive beam configuration used to receive beam-based PRS, e.g., ‘omni’ or ‘wide’ or ‘narrow’.

To detect a narrow beam, the target device may need to have synchronization to the radio network node transmitting the beam, for example by the SS that is periodically transmitted. Furthermore, the target device might need a TRS-like beam when detecting narrow beam-based PRS beams. The network may therefore also configure wider beams and may indicate the narrow beams. Hence, the target device may be signaled wider beam-based PRS beams in combination with a set of associated narrow beam-based PRS in one embodiment. In one embodiment, narrow beams may be configured for cells in the vicinity of the cell serving the target device, while wider beams may be configured for cells further away from the target device. For accurate TOA detection, using wider beams with more repetition can provide same Signal to Noise Ratio (SNR) as transmitting multiple narrow beams and hoping one has good antenna gain.

In one embodiment, the method may further comprise the step of performing 170 self-localization based on the measured TOAs of the beam-based PRSs and known positions of the radio network nodes transmitting the corresponding beam-based PRSs, by using multilateral techniques.

In a second aspect, the present disclosure provides a target device configured to perform beam-based positioning.

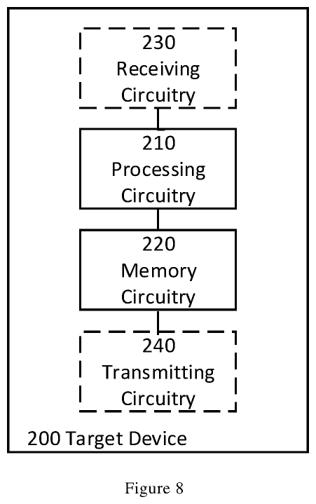

In one exemplary implementation, as illustrated in FIG. 8, the target device 200 may comprise a processor, or a processing circuitry 210, and a memory, or a memory circuitry 220. The memory circuitry 220 may store computer program code, which, when run in the processing circuitry 210, causes the target device 200 to receive, from a location server, a list of transmitter beam IDs, accompanied with corresponding beam-based PRS configurations for one or more radio cells associated with one or more radio network nodes. Different beam-based PRS sequences are used for different beams of one radio network node. The target device 200 may further be caused to determine, based on the received list of transmitter beam IDs accompanied with corresponding PRS configurations, a set of transmitter beams for subsequent measuring. Thereafter, the target device 200 may be caused to receive, from at least one radio network node, beam-based PRS associated with the determined set of transmitter beams and to measure TOA of the beam-based associated with the determined set of transmitter beams.

The target device 200 may, according to one embodiment, further comprise a receiving circuitry 230, which is configured to receive data from other apparatuses, such as a location server and/or a radio network node. In one embodiment, the receiving circuitry 230 may be an omni-directional receiver and the target device 200 may use the omni-directional receiver to detect the beam-based PRS. In another embodiment, the target device 200 may need to adjust and possibly remember the corresponding target device receiver beam for each cell, and different target device receiver beams and/or directions may be needed for different cells.

In one embodiment, the memory circuitry 220 may store computer program code which, when run in the processing circuitry 210, causes the target device 200 to combine, based on the received list of transmitter beam IDs accompanied with corresponding PRS configurations, two or more of the measured TOAs into one TOA.

In some embodiments, the memory circuitry 220 may store computer program code which, when run in the processing circuitry 210, causes the target device 200 to transmit, to the location server, a report based on the measured TOAs of the beam-based PRSs. Additionally, or alternatively, the memory circuitry 220 may further store computer program code which, when run in the processing circuitry 210, causes the target device 200 to transmit, to at least one radio network node, a report based on the measured TOAs of the beam-based PRSs.

Additionally, or alternatively, the target device 200 may further comprise a transmitting circuitry 240 configured to transmit data to other apparatuses, such as a location server and/or a radio network node.

In one embodiment, the memory circuitry 220 may store computer program code which, when run in the processing circuitry 210, causes the target device 200 to receive, from the location server, a capability request associated with positioning to indicate the type of capabilities associated with beam-based measurements. The target device 200 may in response thereto be caused to transmit, to the location server, a capability response indicating measurement configurations supported by the target device 200 in relation to beam-based measurements.

In one embodiment, the memory circuitry 220 may store computer program code which, when run in the processing circuitry 210, causes the target device 200 to determine resources associated with the transmitter beams during which beam-based PRS may be transmitted via corresponding beams.

In one embodiment, the memory circuitry 220 may store computer program code which, when run in the processing circuitry 210, causes the target device 200 to determine at least one radio signal sequence associated with a transmitter beam to be used for a positioning measurement and determine the numerology of the signal.

In one embodiment, the memory circuitry 220 may store computer program code which, when run in the processing circuitry 210, causes the target device 200 to determine, and configure, a receiver beam ID to receive the beam-based PRS associated with a corresponding transmitter beam ID.

In one embodiment, the memory circuitry 220 may store computer program code which, when run in the processing circuitry 210, causes the target device 200 to perform self-localization based on the measured TOAs of the beam-based PRSs and known positions of the radio network nodes transmitting the corresponding beam-based PRSs, by using multilateral techniques.

In a third aspect, the disclosure provides a method, implemented in a location server for performing beam-based positioning.

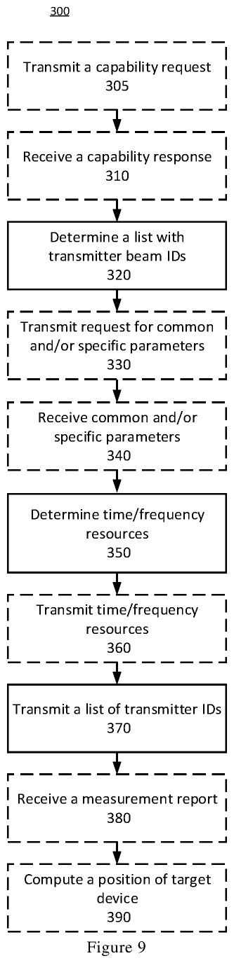

The method is now going to be described with reference to FIGS. 6 and 9, wherein FIG. 9 is a flowchart of the method. The method 300 starts at step 320 by determining, based on a Beam Reference Signal (BRS) Received Power (RP) report from a target device, a list of transmitter beam ID for one or more radio cells associated with one or more radio network nodes. At step 350, resources for beam-based PRS for each radio network node are determined based on the radio network nodes common and beam specific parameters. Thereafter, at step 370 a list of transmitter beam IDs, accompanied with corresponding beam-based PRS configurations for the one or more radio cells associated with one or more radio network nodes, are transmitted to the target device.

Different beam-based PRS sequences are used for different transmitter beams of one radio network node.

Due to this method it may be possible to achieve improved positioning accuracy and to reduce the network overhead due to target device specific beam-based PRS and the possibility to selection of narrow beams in neighboring cells.

In one embodiment, prior information may be used when selecting adequate beams to a target device. For example, information for two or more target devices may be combined when selecting the adequate beams.

The selected beams may, according to one embodiment, be based on prior target device information, e.g. associated with or logically mapped to a specific content of the prior target device information. Such associations or mappings may be maintained in the target device, e.g., as tables or lists. An association or mapping table or mapping rule may also be provided by a network node. The prior information, or assistance data, may correspond to, for example, beam serving target device, cell serving target device, bandwidth supported by the target device, target device accuracy requirements, tracking area, environment type of the target device and/or previous positioning estimate, e.g. from OTDOA. The prior information may further correspond to, for example, a beam in a cell configured as a reference for OTDOA. For example, a target device may for OTDOA be provided several sets of beams where each set has its own reference beam. If the target device selects a certain beam as a reference, e.g. based on its quality or strength, then the target device implicitly may also select the corresponding configured set of other beams to measure from the same and/or neighbouring cells. Additionally or alternatively, the prior information may further correspond to target device beam-related capability and/or maximum number of numerologies the target device may support in parallel.

In one embodiment, the method 300 may further comprise a step of transmitting 360 resources for beam-based PRS to each of the radio network nodes.

In some embodiments, the method 300 may further comprise transmitting 305, to the target device, a capability request associated with positioning to indicate the type of capabilities associated with beam-based measurements, and receiving 310, from the target device, a capability response indicating measurement configurations supported by the target device in relation to beam-based measurements.

The radio network node may, according to some embodiments, use the capability response to determine a set of beams and beam-based PRS signals for the target device to measure for positioning and in order to prevent measurement configurations not supported by the target device. The set of beams and beam-based PRS signals may be indicated to the target device by providing assistance data comprising at least one beam-specific parameter for at least one cell.

In one embodiment, the method 300 may further comprise transmitting 330, to each radio network node, a request for the radio network node's common parameters. Thereafter, the step of receiving 340, from each radio network node 600, common parameters may be performed. The common parameters may include PRS configuration. The information included in the common parameters may then be used when determining the list of transmitter beams to be transmitted to the target device.

In some embodiments, the method may further comprise receiving 380, from the target device, a report based on measured TOAs of the beam-based PRSs. Thereafter, a position of the target device may be computed 390, based on the received report and known positions of the radio network nodes transmitting the corresponding beam-based PRSs, by using multilateral techniques. In one embodiment, the location server may, based on the report received from the target device, also update information of hearable beams in one area, for example if the target device signals the beam used to calculate the TOA. Also, the best beam ID may be used together with antenna information to calculate an AOA to the target device. The location server may then combine received RSTDs and AOA to estimate a target device position.

According to a fourth aspect, there is provided a location server configured to perform beam-based positioning.

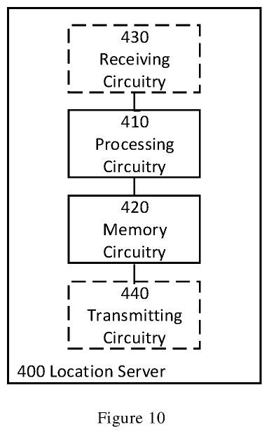

The location server is now going to be described with reference to FIG. 10. The location server 400 may according to one exemplary embodiment comprise a processor, or a processing circuitry 410, and a memory, or a memory circuitry 420. The memory circuitry 420 may store computer program code which, when run in the processing circuitry 410, causes the location server 400 to determine, based on a BRSRP report from a target device 200, a list of transmitter beam IDs for one or more radio cells associated with one or more radio network nodes. The memory circuitry 420 may further store computer program code which, when run in the processing circuitry 410, causes the location server 400 to determine resources for beam-based PRS for each radio network node based on the radio network nodes common and beam specific parameters, and to transmit, to the target device 200, a list of transmitter beam IDs accompanied with corresponding beam-based PRS configurations for the one or more radio cells associated with one or more radio network nodes. Different beam-based PRS sequences are used for different beams of one radio network node.

The location server 400 may, according to one embodiment, further comprise a receiving circuitry 430, which may be configured to receive data from other apparatuses, such as a target device 200 or a radio network node.

In one embodiment, the memory circuitry 420 of the location server may store computer program code which, when run in the processing circuitry 410, further causes the location server 400 to transmit resources for beam-based PRS to each of the radio network nodes.

Additionally, or alternatively, the location server 400 may further comprise a transmitting circuitry 440 configured to transmit data to other apparatuses, such as a target device 200 and/or a radio network node.

In one embodiment, the memory circuitry 420 of the location server may store computer program code which, when run in the processing circuitry 410, further causes the location server 400 to transmit, to the target device 200, a capability request associated with positioning to indicate the type of capabilities associated with beam-based measurements; and to receive, from the target device 200, a capability response indicating measurement configurations supported by the target device 200 in relation to beam-based measurements.

In one embodiment, the memory circuitry 420 may further store computer program code which, when run in the processing circuitry 410, further causes the location server 400 to transmit, to each radio network node, a request for the radio network node's common parameters; and to receive, from each radio network node, common parameters. The common parameters include PRS configuration.

In some embodiments, the location server 400 may further be caused to receive, from the target device 200, a report based on measured TOAs of the beam-based PRSs; and to compute a position of the target device (200), based on the received report and known positions of the radio network nodes transmitting the corresponding beam-based PRSs, by using multilateral techniques.

In a fifth aspect, the disclosure provides a method, implemented in a radio network node for performing beam-based positioning.

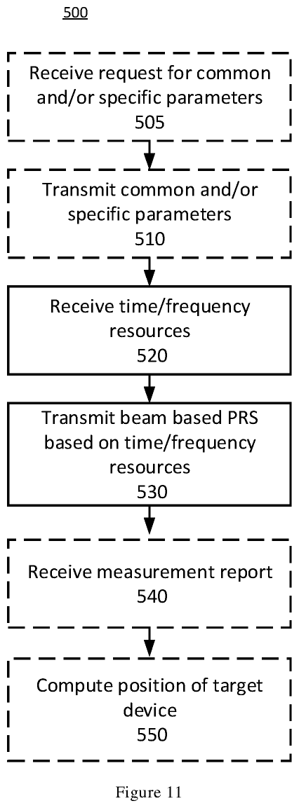

The method is now going to be described with reference to FIGS. 6 and 11. The method comprises transmitting 530, to a target device 200, beam-based PRS. Different beam-based PRS sequences are used for different transmitter beams of the radio network node.

Due to this method, it may be possible to achieve a higher accuracy when determining position of the target device, as the selection of narrow beams in neighbouring cells is enabled.

In one embodiment, the method 500 may further comprise receiving 520, from a location server 400, resources for beam-based PRS.

In one embodiment, the method 500 may further comprise receiving 505, from the location server 400, a request for common parameters; and transmitting 510, to the location server (400), the common parameters. The common parameters may include PRS configuration.

In one embodiment, the method 500 may further comprise receiving 540, from a target device 200, a report based on measured TOAs of the beam-based PRSs. The method 500 may then further comprise the step of computing 550 a position of the target device 200. The position of the target device 200 may be based on the received report and known positions of the radio network nodes transmitting the corresponding beam-based PRSs and the position may be computed by using multilateral techniques.

According to a sixth aspect, there is provided a radio network node configured to perform beam-based positioning.

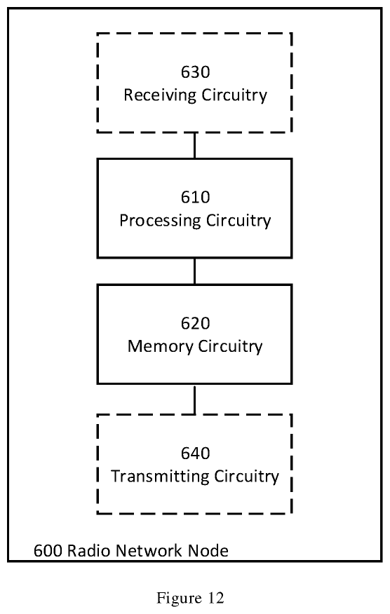

One exemplary embodiment, is now going to be described with reference to FIG. 12. The radio network node 600 may comprise a processor, or a processing circuitry 610 and a memory, or a memory circuitry 620. The memory circuitry 620 may store computer program code which, when run in the processing circuitry 610, causes the radio network node 600 to transmit, to a target device 200, beam-based PRS. Different beam-based PRS sequences are used for different transmitter beams of the radio network node 600.

The radio network node 600 may, according to one embodiment, further comprise a receiving circuitry 630, which may be configured to receive data from other apparatuses, such as a location server 400 and/or a target device 200.

In some embodiments, the memory circuitry 620 may store computer program code which, when run in the processing circuitry 610, further causes the radio network node 600 to receive, from a location server 400, resources for beam-based PRS.

In one embodiment, the memory circuitry 620 may store computer program code which, when run in the processing circuitry 610, further causes the radio network node 600 to receive, from the location server 400, a request for common parameters and to transmit, to the location server 400, common parameters. The common parameters include PRS configuration.

Additionally, or alternatively, the radio network node 600 may further comprise a transmitting circuitry 640 configured to transmit data to other apparatuses, such as a location server 400 and/or a target device 200.

In one embodiment, the memory circuitry 620 may store computer program code which, when run in the processing circuitry 610, further causes the radio network node 600 to receive, from a target device 200, a report, based on measured TOAs of the beam-based PRSs. The radio network node 600 may further be caused to compute a position of the target device 200 based on the received report and known positions of the radio network nodes transmitting the corresponding beam-based PRSs, by using multilateral techniques.

According to a seventh aspect, there is provided a computer program comprising instructions which, when executed on a processing circuitry, cause the processing circuitry to carry out the method according to the first aspect and/or the third aspect and/or the fifth aspect.

According to an eighth aspect, there is provided a carrier containing the computer program of the seventh aspect, wherein the carrier is one of an electronic signal, optical signal, radio signal, or computer readable storage medium.

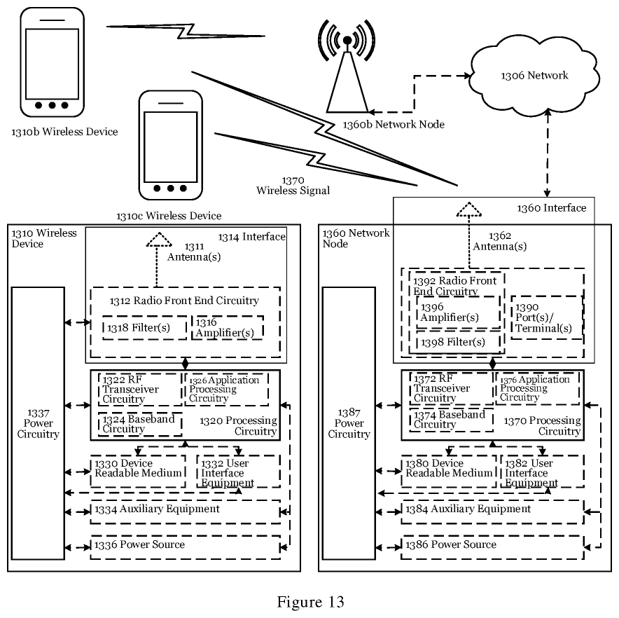

Although the subject matter described herein may be implemented in any appropriate type of system using any suitable components, the embodiments described herein relate to a wireless network, such as the example wireless communication network illustrated in FIG. 13. For simplicity, the wireless communication network of FIG. 13 only depicts network 1306, network nodes 1360 and 1360b, and Wireless Devices (WDs) 1310, 1310b, and 1310c. The wireless communication network may further include any additional elements suitable to support communication between wireless devices or between a wireless device and another communication device, such as a landline telephone. Of the illustrated components, network node 1360 and wireless device (WD) 1310 are depicted with additional detail. The illustrated wireless communication network may provide communication and other types of services to one or more wireless devices to facilitate the wireless devices' access to and/or use of the services provided by the wireless communication network.

The wireless communication network may comprise and/or interface with any type of communication, telecommunication, data, cellular, and/or radio network or other similar type of system. In some embodiments, the wireless communication network may be configured to operate according to specific standards or other types of predefined rules or procedures. Thus, particular embodiments of the wireless communication network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards.

Network 1306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components may work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless communication network to enable and/or provide wireless access to the wireless device and/or to perform other functions (e.g., administration) in the wireless communication network. Examples of network nodes include, but are not limited to, access points (APs) (e.g., radio access points), base stations (BSs) (e.g., radio base stations, Node Bs, and evolved Node Bs (eNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, network node 1360 may be a virtual network node as described in more detail below. More generally, however, network nodes may represent any suitable device (or group of devices) capable, configured, arranged, and/or operable to enable and/or provide a wireless device with access to the wireless communication network or to provide some service to a wireless device that has accessed the wireless communication network.

In FIG. 13, Network node 1360 includes processing circuitry 1370, device readable medium 1380, interface 1390, user interface equipment 1382, auxiliary equipment 1384, power source 1386, power circuitry 1387, and antenna 1362. Although network node 1360 illustrated in the example wireless communication network of FIG. 13 may represent a device that includes the illustrated combination of hardware components, other embodiments may comprise network nodes with different combinations of components. It is to be understood that a network node may comprise any suitable combination of hardware and/or software needed to perform the tasks, features, functions and methods disclosed herein. Moreover, while the components of network node 1360 are depicted as single boxes located within a larger box, or nested within multiple boxes, in practice, a network node may comprise multiple different physical components that make up a single illustrated component (e.g., device readable medium 1380 may comprise multiple separate hard drives as well as multiple RAM modules).

Similarly, network node 1360 may be composed of multiple physically separate components (e.g., a NodeB component and a RNC component, or a BTS component and a BSC component, etc.), which may each have their own respective components. In certain scenarios in which network node 1360 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1360 may be configured to support multiple radio access technologies (RATs). In such embodiments, some components may be duplicated (e.g., separate device readable medium 1380 for the different RATs) and some components may be reused (e.g., the same antenna 1362 may be shared by the RATs). Network node 1360 may also include multiple sets of the various illustrated components for different wireless technologies integrated into network node 1360, such as, for example, GSM, WCDMA, LTE, NR, WiFi, or Bluetooth wireless technologies. These wireless technologies may be integrated into the same or different chip or set of chips and other components within network node 1360.

Processing circuitry 1370 is configured to perform any determining, calculating, or similar operations (e.g., certain obtaining operations) described herein as being provided by a network node. These operations performed by processing circuitry 1370 may include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 may execute instructions stored in device readable medium 1380 or in memory within processing circuitry 1370. Such functionality may include providing any of the various wireless features or benefits discussed herein. In some embodiments, processing circuitry 1370 may include a system on a chip (SOC).

In some embodiments, processing circuitry 1370 may include one or more of radio frequency (RF) transceiver circuitry 1372 and baseband processing circuitry 1374. In some embodiments, radio frequency (RF) transceiver circuitry 1372 and baseband processing circuitry 1374 may be on separate chips (or sets of chips), boards, or units, such as radio units and digital units. In alternative embodiments, part or all of RF transceiver circuitry 1372 and baseband processing circuitry 1374 may be on the same chip or set of chips, boards, or units.

In certain embodiments, some or all of the functionality described herein as being provided by a network node, base station, eNB or other such network device may be provided by processing circuitry 1370 executing instructions stored on device readable medium 1380 or memory within processing circuitry 1370. In alternative embodiments, some or all of the functionality may be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1370. Device readable medium 1380 may store any suitable instructions, data or information, including a computer program, software, an application including one or more of logic, rules, code, tables, etc. and/or other instructions capable of being executed by processing circuitry 1370 and, utilized by network node 1360. Device readable medium 1380 may be used to store any calculations made by processing circuitry 1370 and/or any data received via interface 1390. In some embodiments, processing circuitry 1370 and device readable medium 1380 may be considered to be integrated.

Interface 1390 is used in the wired or wireless communication of signaling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that may be coupled to, or in certain embodiments a part of, antenna 1362. Radio front end circuitry 1392 comprises filters 1398 and amplifiers 1396. Radio front end circuitry 1392 may be connected to antenna 1362 and processing circuitry 1370. Radio front end circuitry may be configured to condition signals communicated between antenna 1362 and processing circuitry 1370. Radio front end circuitry 1392 may receive digital data that is to be sent out to other network nodes or WDs via a wireless connection. Radio front end circuitry 1392 may convert the digital data into a radio signal having the appropriate channel and bandwidth parameters using a combination of filters 1398 and/or amplifiers 1396. The radio signal may then be transmitted via antenna 1362. Similarly, when receiving data, antenna 1362 may collect radio signals which are then converted into digital data by radio front end circuitry 1392. The digital data may be passed to processing circuitry 1370. In other embodiments, the interface may comprise different components and/or different combinations of components.

In certain alternative embodiments, network node 1360 may not include separate radio front end circuitry 1392, instead, processing circuitry 1370 may comprise radio front end circuitry and may be connected to antenna 1362 without separate radio front end circuitry 1392. Similarly, in some embodiments, all or some of RF transceiver circuitry 1372 may be considered a part of interface 1390. In still other embodiments, interface 1390 may include one or more ports or terminals 1394, radio front end circuitry 1392, and RF transceiver circuitry 1372, as part of a radio unit (not shown), and interface 1390 may communicate with baseband processing circuitry 1374, which is part of a digital unit (not shown).

Antenna 1362 may include one or more antennas, or antenna arrays, configured to send and/or receive wireless signals. Antenna 1362 may be coupled to radio front end circuitry 1390 and may be any type of antenna capable of transmitting and receiving data and/or signals wirelessly. In some embodiments, antenna 1362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1362 may be separate from network node 1360 and may be connectable to network node 1360 through an interface or port.

Antenna 1362, interface 1390, and/or processing circuitry 1370 may be configured to perform any receiving operations and/or certain obtaining operations described herein as being performed by a network node. Any information, data and/or signals may be received from a wireless device, another network node and/or any other network equipment. Similarly, antenna 1362, interface 1390, and/or processing circuitry 1370 may be configured to perform any transmitting operations described herein as being performed by a network node. Any information, data and/or signals may be transmitted to a wireless device, another network node and/or any other network equipment.

Power circuitry 1387 may comprise, or be coupled to, power management circuitry and is configured to supply the components of network node 1360 with power for performing the functionality described herein. Power circuitry 1387 may receive power from power source 1386. Power source 1386 and/or power circuitry 1387 may be configured to provide power to the various components of network node 1360 in a form suitable for the respective components (e.g., at a voltage and current level needed for each respective component). Power source 1386 may either be included in, or external to, power circuitry 1387 and/or network node 1360. For example, network node 1360 may be connectable to an external power source (e.g., an electricity outlet) via an input circuitry or interface such as an electrical cable, whereby the external power source supplies power to power circuitry 1387. As a further example, power source 1386 may comprise a source of power in the form of a battery or battery pack which is connected to, or integrated in, power circuitry 1387. The battery may provide backup power should the external power source fail. Other types of power sources, such as photovoltaic devices, may also be used.

Alternative embodiments of network node 1360 may include additional components beyond those shown in FIG. 13 that may be responsible for providing certain aspects of the network node's functionality, including any of the functionality described herein and/or any functionality necessary to support the subject matter described herein. For example, network node 1360 may include user interface equipment to allow input of information into network node 1360 and to allow output of information from network node 1360. This may allow a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal.

Furthermore, a WD as described above may be mobile, in which case it may also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 may include multiple sets of one or more of the illustrated components for different wireless technologies supported by WD 1310, such as, for example, GSM, WCDMA, LTE, NR, WiFi, WiMAX, or Bluetooth wireless technologies, just to mention a few. These wireless technologies may be integrated into the same or different chips or set of chips as other components within WD 1310.

Antenna 1311 may include one or more antennas or antenna arrays, configured to send and/or receive wireless signals, and is connected to interface 1314. In certain alternative embodiments, antenna 1311 may be separate from WD 1310 and be connectable to WD 1310 through an interface or port. Antenna 1311, interface 1314, and/or processing circuitry 1320 may be configured to perform any receiving or transmitting operations described herein as being performed by a WD. Any information, data and/or signals may be received from a network node and/or another WD. In some embodiments, radio front end circuitry and/or antenna 1311 may be considered an interface.

As illustrated, interface 1314 comprises radio front end circuitry 1312 and antenna 1311. Radio front end circuitry 1312 comprise one or more filters 1313 and amplifiers 1316. Radio front end circuitry 1314 is connected to antenna 1311 and processing circuitry 1320, and is configured to condition signals communicated between antenna 1311 and processing circuitry 1320. Radio front end circuitry 1312 may be coupled to or a part of antenna 1311. In some embodiments, WD 1310 may not include separate radio front end circuitry 1312; rather, processing circuitry 1320 may comprise radio front end circuitry and may be connected to antenna 1311. Similarly, in some embodiments, some or all of RF transceiver circuitry 1322 may be considered a part of interface 1314. Radio front end circuitry 1312 may receive digital data that is to be sent out to other network nodes or WDs via a wireless connection. Radio front end circuitry 1312 may convert the digital data into a radio signal having the appropriate channel and bandwidth parameters using a combination of filters 1313 and/or amplifiers 1316. The radio signal may then be transmitted via antenna 1311. Similarly, when receiving data, antenna 1311 may collect radio signals which are then converted into digital data by radio front end circuitry 1312.

The digital data may be passed to processing circuitry 1320. In other embodiments, the interface may comprise different components and/or different combinations of components.

Processing circuitry 1320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality may include providing any of the various wireless features or benefits discussed herein. For example, processing circuitry 1320 may execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry may comprise different components and/or different combinations of components. In certain embodiments processing circuitry 1320 of WD 1310 may comprise a SOC. In some embodiments, RF transceiver circuitry 1322, baseband processing circuitry 1324, and application processing circuitry 1326 may be on separate chips or sets of chips. In alternative embodiments, part or all of baseband processing circuitry 1324 and application processing circuitry 1326 may be combined into one chip or set of chips, and RF transceiver circuitry 1322 may be on a separate chip or set of chips. In still alternative embodiments, part or all of RF transceiver circuitry 1322 and baseband processing circuitry 1324 may be on the same chip or set of chips, and application processing circuitry 1326 may be on a separate chip or set of chips. In yet other alternative embodiments, part or all of RF transceiver circuitry 1322, baseband processing circuitry 1324, and application processing circuitry 1326 may be combined in the same chip or set of chips. In some embodiments, RF transceiver circuitry 1322 may be a part of interface 1314. RF transceiver circuitry 1322 may condition RF signals for processing circuitry 1320.

In certain embodiments, some or all of the functionality described herein as being performed by a WD may be provided by processing circuitry 1320 executing instructions stored on device readable medium 1330, which in certain embodiments may be a computer-readable storage medium. In alternative embodiments, some or all of the functionality may be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 may be configured to perform any determining, calculating, or similar operations (e.g., certain obtaining operations) described herein as being performed by a WD. These operations, as performed by processing circuitry 1320, may include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 may be operable to store a computer program, software, an application including one or more of logic, rules, code, tables, etc. and/or other instructions capable of being executed by processing circuitry 1320. Device readable medium 1330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1320. In some embodiments, processing circuitry 1320 and device readable medium 1330 may be considered to be integrated.

User interface equipment 1332 may provide components that allow for a human user to interact with WD 1310. Such interaction may be of many forms, such as visual, audial, tactile, etc. User interface equipment 1332 may be operable to produce output to the user and to allow the user to provide input to WD 1310. The type of interaction may vary depending on the type of user interface equipment 1332 installed in WD 1310. For example, if WD 1310 is a smart phone, the interaction may be via a touch screen; if WD 1310 is a smart meter, the interaction may be through a screen that provides usage (e.g., the number of gallons used) or a speaker that provides an audible alert (e.g., if smoke is detected). User interface equipment 1332 may include input interfaces, devices and circuits, and output interfaces, devices and circuits. User interface equipment 1332 is configured to allow input of information into WD 1310, and is connected to processing circuitry 1320 to allow processing circuitry 1320 to process the input information. User interface equipment 1332 may include, for example, a microphone, a proximity or other sensor, keys/buttons, a touch display, one or more cameras, a USB port, or other input circuitry. User interface equipment 1332 is also configured to allow output of information from WD 1310, and to allow processing circuitry 1320 to output information from WD 1310. User interface equipment 1332 may include, for example, a speaker, a display, vibrating circuitry, a USB port, a headphone interface, or other output circuitry. Using one or more input and output interfaces, devices, and circuits, of user interface equipment 1332, WD 1310 may communicate with end users and/or the wireless network, and allow them to benefit from the functionality described herein.

Auxiliary equipment 1334 is operable to provide more specific functionality which may not be generally performed by WDs. This may comprise specialized sensors for doing measurements for various purposes, interfaces for additional types of communication such as wired communications etc. The inclusion and type of components of auxiliary equipment 1334 may vary depending on the embodiment and/or scenario.

Power source 1336 may, in some embodiments, be in the form of a battery or battery pack. Other types of power sources, such as an external power source (e.g., an electricity outlet), photovoltaic devices or power cells, may also be used. WD 1310 may further comprise power circuitry 1337 for delivering power from power source 1336 to the various parts of WD 1310 which need power from power source 1336 to carry out any functionality described or indicated herein. Power circuitry 1337 may in certain embodiments comprise power management circuitry. Power circuitry 1337 may additionally or alternatively be operable to receive power from an external power source; in which case WD 1310 may be connectable to the external power source (such as an electricity outlet) via input circuitry or an interface such as an electrical power cable. Power circuitry 1337 may also in certain embodiments be operable to deliver power from an external power source to power source 1336. This may be, for example, for the charging of power source 1336. Power circuitry 1337 may perform any formatting, converting, or other modification to the power from power source 1336 to make the power suitable for the respective components of WD 1310 to which power is supplied.

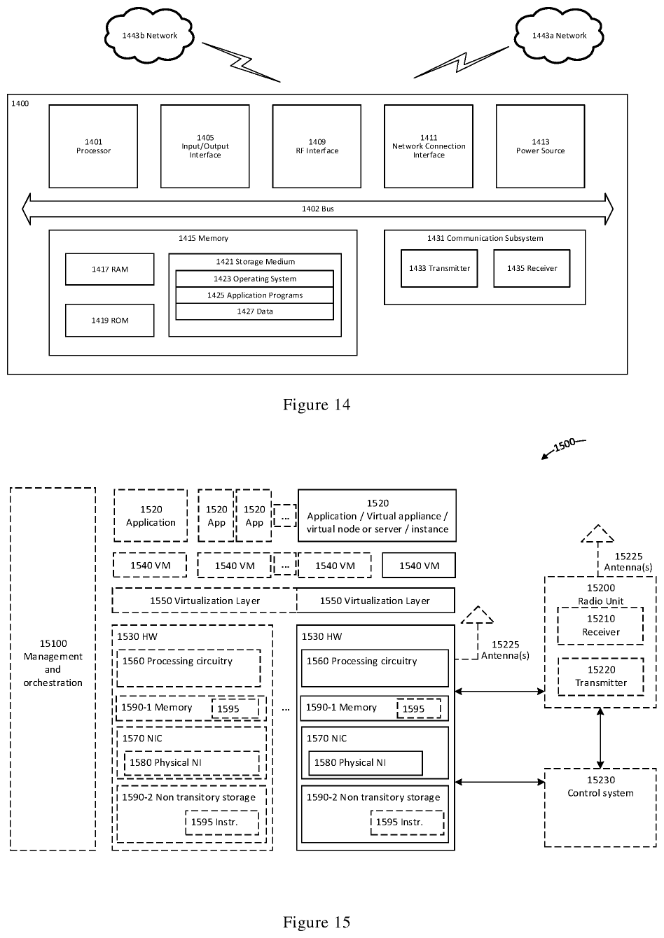

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1400 may be any UE identified by the 3rd Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1414, and storage medium 1421 or the like, communication subsystem 1431, power source 1433, and/or any other component, or any combination thereof. Storage medium 1421 includes operating system 1423, application program 1425, and data 1427. In other embodiments, storage medium 1421 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1401 may be configured to process computer instructions and data. Processing circuitry 1401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 may include two central processing units (CPUs). Data may be information in a form suitable for use by a computer.

In the depicted embodiment, input/output interface 1405 may be configured to provide a communication interface to an input device, output device, or input and output device. UE 1400 may be configured to use an output device via input/output interface 1405. An output device may use the same type of interface port as an input device. For example, a USB port may be used to provide input to and output from UE 1400. The output device may be a speaker, a sound card, a video card, a display, a monitor, a printer, an actuator, an emitter, a smartcard, another output device, or any combination thereof. UE 1400 may be configured to use an input device via input/output interface 1405 to allow a user to capture information into UE 1400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1409 may be configured to provide a communication interface to RF components such as a transmitter, a receiver, and an antenna. Network connection interface 1411 may be configured to provide a communication interface to network 1443a. Network 1443a may encompass wired and/or wireless networks such as a local-area network (LAN), a wide-area network (WAN), a computer network, a wireless network, a telecommunications network, another like network or any combination thereof. For example, network 1443a may comprise a Wi-Fi network. Network connection interface 1411 may be configured to include a receiver and a transmitter interface used to communicate with one or more other devices over a communication network according to one or more communication protocols, such as Ethernet, TCP/IP, SONET, ATM, or the like. Network connection interface 1411 may implement receiver and transmitter functionality appropriate to the communication network links (e.g., optical, electrical, and the like). The transmitter and receiver functions may share circuit components, software or firmware, or alternatively may be implemented separately.

RAM 1417 may be configured to interface via bus 1402 to processing circuitry 1401 to provide storage or caching of data or computer instructions during the execution of software programs such as the operating system, application programs, and device drivers. ROM 1414 may be configured to provide computer instructions or data to processing circuitry 1401. For example, ROM 1414 may be configured to store invariant low-level system code or data for basic system functions such as basic input and output (I/O), startup, or reception of keystrokes from a keyboard that are stored in a non-volatile memory. Storage medium 1421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 may be configured to include operating system 1423, application program 1425 such as a web browser application, a widget or gadget engine or another application, and data file 1427. Storage medium 1421 may store, for use by UE 1400, any of a variety of various operating systems or combinations of operating systems.

Storage medium 1421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 may allow UE 1400 to access computer-executable instructions, application programs or the like, stored on transitory or non-transitory memory media, to off-load data, or to upload data. An article of manufacture, such as one utilizing a communication system may be tangibly embodied in storage medium 1421, which may comprise a device readable medium.

In FIG. 14, processing circuitry 1401 may be configured to communicate with network 1443b using communication subsystem 1431. Network 1443a and network 1443b may be the same network or networks or different network or networks. Communication subsystem 1431 may be configured to include one or more transceivers used to communicate with network 1443b. For example, communication subsystem 1431 may be configured to include one or more transceivers used to communicate with one or more remote transceivers of another device capable of wireless communication such as another WD, UE, or base station of a radio access network (RAN) according to one or more communication protocols, such as IEEE 802.14, CDMA, WCDMA, GSM, LTE, UTRAN, WiMax, or the like. Each transceiver may include transmitter 1433 and/or receiver 1435 to implement transmitter or receiver functionality, respectively, appropriate to the RAN links (e.g., frequency allocations and the like). Further, transmitter 1433 and receiver 1435 of each transceiver may share circuit components, software or firmware, or alternatively may be implemented separately.

In the illustrated embodiment, the communication functions of communication subsystem 1431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 may include cellular communication, Wi-Fi communication, Bluetooth communication, and GPS communication. Network 1443b may encompass wired and/or wireless networks such as a local-area network (LAN), a wide-area network (WAN), a computer network, a wireless network, a telecommunications network, another like network or any combination thereof. For example, network 1443b may be a cellular network, a Wi-Fi network, and/or a near-field network. Power 5 source 1413 may be configured to provide alternating current (AC) or direct current (DC) power to components of UE 1400.

The features, benefits and/or functions described herein may be implemented in one of the components of UE 1400 or partitioned across multiple components of UE 1400. Further, the features, benefits, and/or functions described herein may be implemented in any combination of hardware, software or firmware. In one example, communication subsystem 1431 may be configured to include any of the components described herein. Further, processing circuitry 1401 may be configured to communicate with any of such components over bus 1402. In another example, any of such components may be represented by program instructions stored in memory that when executed by processing circuitry 1401 perform the corresponding functions described herein. In another example, the functionality of any of such components may be partitioned between processing circuitry 1401 and communication subsystem 1431. In another example, the non-computationally intensive functions of any of such components may be implemented in software or firmware and the computationally intensive functions may be implemented in hardware.

FIG. 15 is a schematic block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node may be entirely virtualized.

The functions may be implemented by one or more applications 1520 (which may alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which may be commercial off-the-shelf (COTS) processors, dedicated Application Specific Integrated Circuits (ASICs), or any other type of processing circuitry including digital or analogue hardware components or special purpose processors. Each hardware device may comprise memory 1590-1 which may be non-persistent memory for temporarily storing instructions 1595 or software executed by processing circuitry 1560. Each hardware device may comprise one or more network interface controllers (NICs) 1570, also known as network interface cards, which include physical network interface 1580. Each hardware device may also include non-transitory, persistent, machine-readable storage media 1590-2 having stored therein software 1595 and/or instructions executable by processing circuitry 1560. Software 1595 may include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540, comprise virtual processing, virtual memory, virtual networking or interface and virtual storage, and may be run by a corresponding virtualization layer 1550 or hypervisor. Different embodiments of the instance of virtual appliance 1520 may be implemented on one or more of virtual machines 1540, and the implementations may be made in different ways.

During operation, processing circuitry 1560 executes software 1595 to instantiate the hypervisor or virtualization layer 1550, which may sometimes be referred to as a virtual machine monitor (VMM). Virtualization layer 1550 may present a virtual operating platform that appears like networking hardware to virtual machine 1540.

As shown in FIG. 15, hardware 1530 may be a standalone network node with generic or specific components. Hardware 1530 may comprise antenna 15225 and may implement some functions via virtualization. Alternatively, hardware 1530 may be part of a larger cluster of hardware (e.g. such as in a data center or customer premise equipment (CPE)) where many hardware nodes work together and are managed via management and orchestration (MANO) 15100, which, among others, oversees lifecycle management of applications 1520.

Virtualization of the hardware is in some contexts referred to as network function virtualization (NFV). NFV may be used to consolidate many network equipment types onto industry standard high-volume server hardware, physical switches, and physical storage, which can be located in data centres, and customer premise equipment.

In the context of NFV, virtual machine 1540 may be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 may be coupled to one or more antennas 15225. Radio units 15200 may communicate directly with hardware nodes 1530 via one or more appropriate network interfaces and may be used in combination with the virtual components to provide a virtual node with radio capabilities, such as a radio access node or a base station.

In some embodiments, some signaling can be affected with the use of control system 15230 which may alternatively be used for communication between the hardware nodes 1530 and radio units 15200.

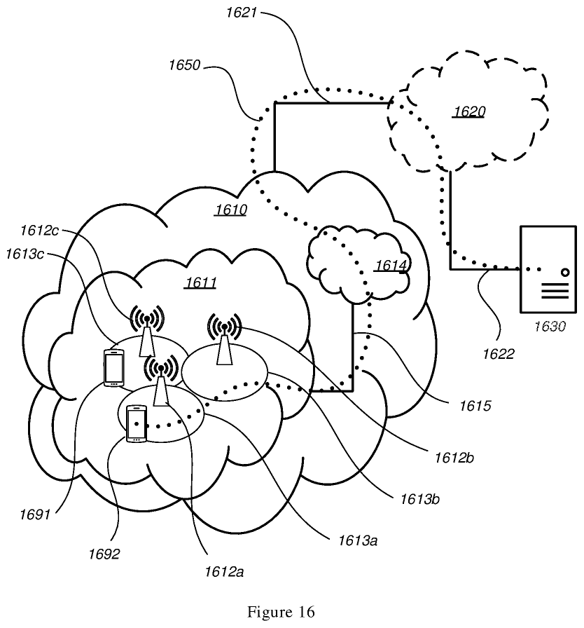

With reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which may be embodied in the hardware and/or software of a standalone server, a cloud-implemented server, a distributed server or as processing resources in a server farm. Host computer 1630 may be under the ownership or control of a service provider, or may be operated by the service provider or on behalf of the service provider. Connections 1616 and 1622 between telecommunication network 1610 and host computer 1630 may extend directly from core network 1614 to host computer 1630 or may go via an optional intermediate network 1620. Intermediate network 1620 may be one of, or a combination of more than one of, a public, private or hosted network; intermediate network 1620, if any, may be a backbone network or the Internet; in particular, intermediate network 1620 may comprise two or more sub-networks (not shown).

The communication system of FIG. 16 as a whole enables connectivity between the connected UEs 1691, 1692 and host computer 1630. The connectivity may be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 may be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

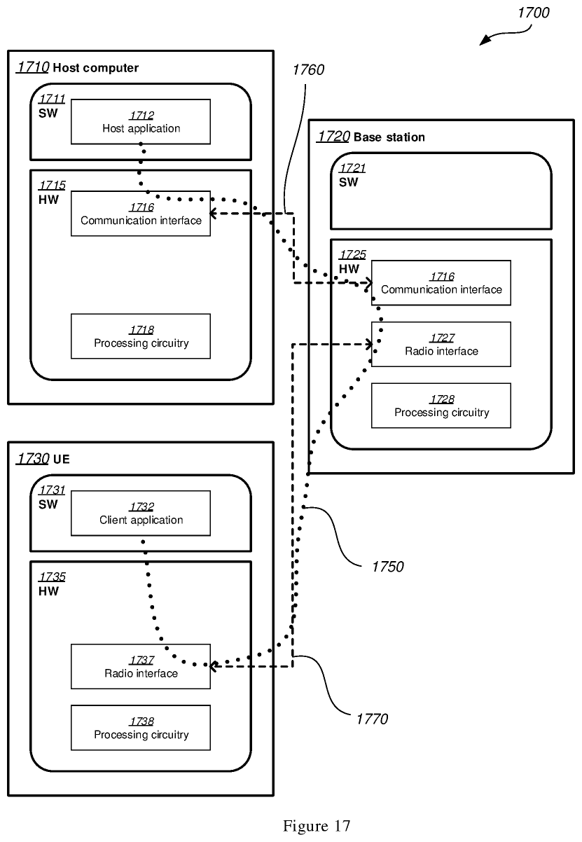

Example implementations, in accordance with an embodiment, of the UE, base station and host computer discussed in the preceding paragraphs will now be described with reference to FIG. 17. In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which may have storage and/or processing capabilities. In particular, processing circuitry 1718 may comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 may be operable to provide a service to a remote user, such as UE 1730 connecting via OTT connection 1750 terminating at UE 1730 and host computer 1710. In providing the service to the remote user, host application 1712 may provide user data which is transmitted using OTT connection 1750.

Communication system 1700 further includes base station 1720 provided in a telecommunication system and comprising hardware 1725 enabling it to communicate with host computer 1710 and with UE 1730. Hardware 1725 may include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 may be configured to facilitate connection 1760 to host computer 1710. Connection 1760 may be direct, or it may pass through a core network (not shown in FIG. 17) of the telecommunication system and/or through one or more intermediate networks outside the telecommunication system. In the embodiment shown, hardware 1725 of base station 1720 further includes processing circuitry 1728, which may comprise one or more programmable processors, application-specific integrated circuits, field programmable gate arrays or combinations of these (not shown) adapted to execute instructions. Base station 1720 further has software 1716 stored internally or accessible via an external connection.

Communication system 1700 further includes UE 1730 already referred to. Its hardware 1735 may include radio interface 1737 configured to set up and maintain wireless connection 1770 with a base station serving a coverage area in which UE 1730 is currently located. Hardware 1735 of UE 1730 further includes processing circuitry 1738, which may comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 may be operable to provide a service to a human or non-human user via UE 1730, with the support of host computer 1710. In host computer 1710, an executing host application 1712 may communicate with the executing client application 1732 via OTT connection 1750 terminating at UE 1730 and host computer 1710. In providing the service to the user, client application 1732 may receive request data from host application 1712 and provide user data in response to the request data. OTT connection 1750 may transfer both the request data and the user data. Client application 1732 may interact with the user to generate the user data that it provides.

It is noted that host computer 1710, base station 1720 and UE 1730 illustrated in FIG. 17 may be similar or identical to host computer 1630, one of base stations 1612a, 1612b, 1612c and one of UEs 1691, 1692 of FIG. 16, respectively. This is to say, the inner workings of these entities may be as shown in FIG. 17 and independently, the surrounding network topology may be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure may determine the routing, which it may be configured to hide from UE 1730 or from the service provider operating host computer 1710, or both. While OTT connection 1750 is active, the network infrastructure may further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments improve the performance of OTT services provided to UE 1730 using OTT connection 1750, in which wireless connection 1770 forms the last segment. More precisely, the teachings of these embodiments may improve the data rate and thereby provide benefits such as better responsiveness.

A measurement procedure may be provided for the purpose of monitoring data rate, latency and other factors on which the one or more embodiments improve. There may further be an optional network functionality for reconfiguring OTT connection 1750 between host computer 1710 and UE 1730, in response to variations in the measurement results. The measurement procedure and/or the network functionality for reconfiguring OTT connection 1750 may be implemented in software 1711 and hardware 1715 of host computer 1710 or in software 1731 and hardware 1735 of UE 1730, or both. In embodiments, sensors (not shown) may be deployed in or in association with communication devices through which OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of OTT connection 1750 may include message format, retransmission settings, preferred routing etc.; the reconfiguring need not affect base station 1720, and it may be unknown or imperceptible to base station 1720. Such procedures and functionalities may be known and practiced in the art. In certain embodiments, measurements may involve proprietary UE signaling facilitating host computer 1710's measurements of throughput, propagation times, latency and the like. The measurements may be implemented in that software 1711 and 1731 causes messages to be transmitted, in particular empty or ‘dummy’ messages, using OTT connection 1750 while it monitors propagation times, errors etc.

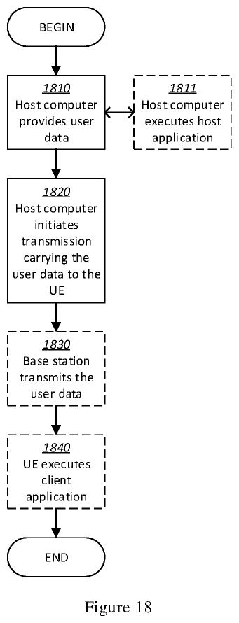

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1810, the host computer provides user data. In substep 1811 (which may be optional) of step 1810, the host computer provides the user data by executing a host application. In step 1820, the host computer initiates a transmission carrying the user data to the UE. In step 1830 (which may be optional), the base station transmits to the UE the user data which was carried in the transmission that the host computer initiated, in accordance with the teachings of the embodiments described throughout this disclosure. In step 1840 (which may also be optional), the UE executes a client application associated with the host application executed by the host computer.

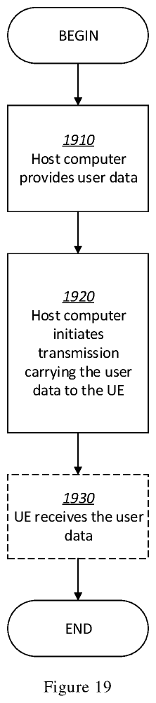

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission may pass via the base station, in accordance with the teachings of the embodiments described throughout this disclosure. In step 1930 (which may be optional), the UE receives the user data carried in the transmission.

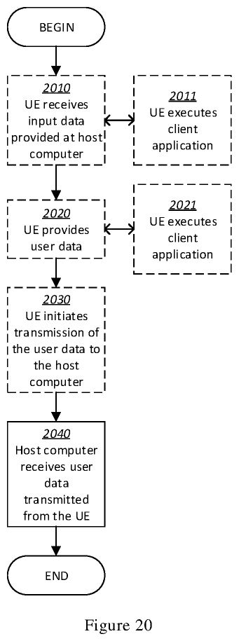

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

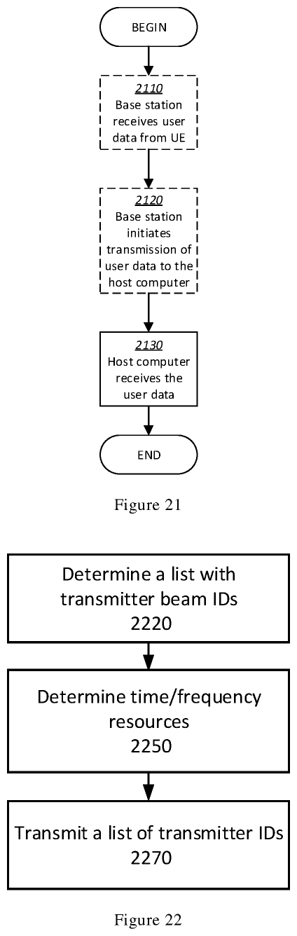

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

FIG. 22 depicts a method in accordance with particular embodiments, the method begins at step 2220 with determining, based on a BRSRP report from a target device, a list of transmitter beam IDs for one or more radio cells associated with one or more radio network nodes. Thereafter, the method continue at step 2250 with determining resources for beam-based PRS for each radio network node based on the radio network nodes common and beam specific parameters and step 2270 with transmitting, to the target device, a list of transmitter beam IDs, accompanied with corresponding beam-based PRS configurations for the one or more radio cells associated with one or more radio network nodes, wherein different beam-based PRS sequences are used for different transmitter beams of one radio network node.

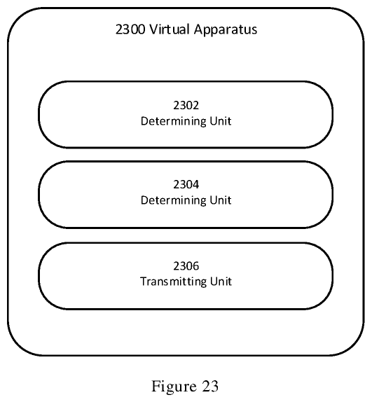

FIG. 23 illustrates a schematic block diagram of an apparatus 2300 in a wireless network (for example, the wireless network shown in FIG. 13). The apparatus may be implemented in a wireless device or network node (e.g., wireless device 1310 or network node 1360 shown in FIG. 13). Apparatus 2300 is operable to carry out the example method described with reference to FIG. 22 and possibly any other processes or methods disclosed herein. It is also to be understood that the method of FIG. 22 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining unit 2302, determining unit 2304, and transmitting unit 2306, and any other suitable units of apparatus 2300 to perform corresponding functions according one or more embodiments of the present disclosure.

As illustrated in FIG. 23, apparatus 300 includes determining unit 2302, determining unit 2304 and transmitting unit 2306. The determining unit 2302 is configured to determine, based on a BRSRP report from a target device, a list of transmitter beam IDs for one or more radio cells associated with one or more radio network nodes. The determining unit 2304 is configured to determine resources for beam-based PRS for each radio network node based on the radio network nodes common and beam specific parameters. The transmitting unit 2306 is configured to transmit, to the target device, a list of transmitter beam IDs, accompanied with corresponding beam-based PRS configurations for the one or more radio cells associated with one or more radio network nodes. Different beam-based PRS sequences are used for different transmitter beams of one radio network node.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Numbered Embodiments in Particular Related to FIGS. 13-23

Group A Embodiments
1. A method performed by a wireless device performing beam-based positioning, the method comprising:
   receiving, from a location server, a list of transmitter beam IDentities, IDs, accompanied with corresponding beam-based Positioning Reference Signal, PRS, configurations for one or more radio cells associated with one or more radio network nodes, wherein different beam-based PRS sequences are used for different transmitter beams of one radio network node;
   determining, based on the received list of transmitter beam IDs accompanied with corresponding PRS configurations, a set of transmitter beams for subsequent measuring;
   receiving, from at least one radio network node, beam-based PRSs associated with the determined set of transmitter beams; and
   measuring Time Of Arrival, TOA, of the beam-based PRSs associated with the determined set of transmitter beams.
2. The method according to embodiment 1, wherein the method further comprises:
   combining, based on the received list of transmitter beam IDs accompanied with corresponding PRS configurations, two or more of the measured TOAs into one TOA.
3. The method according to any of embodiment 1 and 2, wherein the method further comprises:
   transmitting, to the location server, a report based on the measured TOAs of the beam-based PRSs.
4. The method according to any of embodiment 1 to 3, wherein the method further comprises:
   transmitting, to at least one radio network node, a report based on the measured TOAs of the beam-based PRSs.
5. The method according to any of embodiment 1 to 4, wherein the method further comprises:
   receiving, from the location server, a capability request associated with positioning to indicate type of capabilities associated with beam-based measurements supported by the wireless device; and in response thereto
   transmitting, to the location server, a capability response indicating measurement configurations supported by the wireless device in relation to beam-based measurements.
6. The method of any of the previous embodiments, further comprising:
   determining resources associated with the transmitter beams during which beam-based PRS may be transmitted via corresponding transmitter beams.
7. The method of any of the previous embodiments, further comprising:
   determining at least one radio signal sequence associated with a transmitter beam to be used for a positioning measurement and determining the numerology of the signal.
8. The method of any of the previous embodiments, further comprising:
   determining, and configuring, a receiver beam ID to receive the beam-based PRS associated with a corresponding transmitter beam ID.
9. The method of any of the previous embodiments, further comprising:
   performing self-localization based on the measured TOAs of the beam-based PRSs and known positions of the radio network nodes transmitting the corresponding beam-based PRSs, by using multilateral techniques.
10. The method of any of the previous embodiments, further comprising:
   providing user data; and
   forwarding the user data to a host computer via the transmission to the base station.

Group B Embodiments
11. A method performed by a base station for performing beam-based positioning, the method comprising:
   transmitting, to a wireless device, beam-based Positioning Reference Signal, PRS, wherein different beam-based PRS sequences are used for different transmitter beams of the radio network node.
12. The method according to embodiment 10, wherein the method further comprises:
   receiving, from a location server, resources for beam-based PRS.
13. The method according to embodiment 10 or 11, wherein the method further comprises:
   receiving, from the location server, a request for common parameters; and
   transmitting, to the location server, common parameters.
14. The method according to any of embodiment 10 to 12, wherein the method further comprises:
   receiving, from a wireless device, a report based on measured TOAs of the beam-based PRSs; and
   computing a position of the wireless device, based on the received report and known positions of the radio network nodes transmitting the corresponding beam-based PRSs, by using multilateral techniques
15. The method of any of the previous embodiments, further comprising:
   obtaining user data; and
   forwarding the user data to a host computer or a wireless device.

Group C Embodiments
16. A wireless device for performing beam-based positioning, the wireless device comprising:
   processing circuitry configured to perform any of the steps of any of the Group A embodiments; and
   power supply circuitry configured to supply power to the wireless device.
17. A base station for performing beam-based positioning, the base station comprising:
   processing circuitry configured to perform any of the steps of any of the Group B embodiments; and
   power supply circuitry configured to supply power to the base station.
18. A user equipment (UE) for performing beam-based positioning, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
19. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
20. The communication system of the previous embodiment further including the base station.
21. The communication system of the previous 2 embodiments, further including the UE, wherein the UE is configured to communicate with the base station.
22. The communication system of the previous 3 embodiments, wherein:
   the processing circuitry of the host computer is configured to execute a host application, thereby providing the user data; and
   the UE comprises processing circuitry configured to execute a client application associated with the host application.
23. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments
24. The method of the previous embodiment, further comprising, at the base station, transmitting the user data.
25. The method of the previous 2 embodiments, wherein the user data is provided at the host computer by executing a host application, the method further comprising, at the UE, executing a client application associated with the host application.
26. A user equipment (UE) configured to communicate with a base station, the UE comprising a radio interface and processing circuitry configured to performs any of the previous 3 embodiments.
27. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
28. The communication system of the previous embodiment, wherein the cellular network further includes a base station configured to communicate with the UE.
29. The communication system of the previous 2 embodiments, wherein:
   the processing circuitry of the host computer is configured to execute a host application, thereby providing the user data; and
   the UE's processing circuitry is configured to execute a client application associated with the host application.
30. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
31. The method of the previous embodiment, further comprising at the UE, receiving the user data from the base station.
32. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
33. The communication system of the previous embodiment, further including the UE.
34. The communication system of the previous 2 embodiments, further including the base station, wherein the base station comprises a radio interface configured to communicate with the UE and a communication interface configured to forward to the host computer the user data carried by a transmission from the UE to the base station.
35. The communication system of the previous 3 embodiments, wherein:
   the processing circuitry of the host computer is configured to execute a host application; and
   the UE's processing circuitry is configured to execute a client application associated with the host application, thereby providing the user data.
36. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
37. A method implemented in a communication system including a host computer, a base station and a user equipment (UE), the method comprising:
   at the host computer, receiving user data transmitted to the base station from the UE, wherein the UE performs any of the steps of any of the Group A embodiments.
38. The method of the previous embodiment, further comprising, at the UE, providing the user data to the base station.
39. The method of the previous 2 embodiments, further comprising:
   at the UE, executing a client application, thereby providing the user data to be transmitted; and
   at the host computer, executing a host application associated with the client application.
40. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
41. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
42. The communication system of the previous embodiment further including the base station.
43. The communication system of the previous 2 embodiments, further including the UE, wherein the UE is configured to communicate with the base station.
44. The communication system of the previous 3 embodiments, wherein:
   the processing circuitry of the host computer is configured to execute a host application;
   the UE is configured to execute a client application associated with the host application, thereby providing the user data to be received by the host computer.
45. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
46. The method of the previous embodiment, further comprising at the base station, receiving the user data from the UE.
47. The method of the previous 2 embodiments, further comprising at the base station, initiating a transmission of the received user data to the host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1.-38. (canceled)

39. A method, implemented in a target device for performing beam-based positioning, the method comprising:
receiving, from a location server, a list of transmitter beam Identities (IDs) accompanied with corresponding beam-based Positioning Reference Signal (PRS) configurations for one or more radio cells associated with one or more radio network nodes, wherein different beam-based PRS sequences are used for different transmitter beams of one radio network node;
determining, based on the received list of transmitter beam IDs accompanied with corresponding PRS configurations, a set of transmitter beams for subsequent measuring;
receiving, from at least one radio network node, beam-based PRSs associated with the determined set of transmitter beams; and
measuring Time Of Arrival (TOA) of the beam-based PRSs associated with the determined set of transmitter beams.

40. The method according to claim 39, wherein the method further comprises:
combining, based on the received list of transmitter beam IDs accompanied with corresponding PRS configurations, two or more of the measured TOAs into one TOA.

41. The method according to claim 39, wherein the method further comprises:
transmitting, to the location server or to at least one radio network node, a report based on the measured TOAs of the beam-based PRSs.

42. The method according to claim 39, wherein the method further comprises:
receiving, from the location server, a capability request associated with positioning to indicate type of capabilities associated with beam-based measurements supported by the target device; and in response thereto
transmitting, to the location server, a capability response indicating measurement configurations supported by the target device in relation to beam-based measurements.

43. The method according to claim 39, wherein determining a set of transmitter beams for subsequent measuring further comprises:
determining resources associated with the transmitter beams during which beam-based PRS may be transmitted via corresponding transmitter beams.

44. The method according to claim 39, wherein the method further comprises:
determining at least one radio signal sequence associated with a transmitter beam to be used for a positioning measurement and determining the numerology of the signal.

45. The method according to claim 39, wherein the method further comprises:
determining, and configuring, a receiver beam ID to receive the beam-based PRS associated with a corresponding transmitter beam ID.

46. The method according to claim 39, wherein the method further comprises:
performing self-localization based on the measured TOAs of the beam-based PRSs and known positions of the radio network nodes transmitting the corresponding beam-based PRSs, by using multilateral techniques.

47. A target device configured to performing beam-based positioning, the target device comprises:
processing circuitry; and
memory circuitry storing computer program code which, when run in the processing circuitry, causes the target device to:
receive, from a location server, a list of transmitter beam IDentities, IDs, accompanied with corresponding beam-based Positioning Reference Signal, PRS, configurations for one or more radio cells associated with one or more radio network nodes, wherein different beam-based PRS sequences are used for different beams of one radio network node;
determine, based on the received list of transmitter beam IDs accompanied with corresponding PRS configurations, a set of transmitter beams for subsequent measuring;
receive, from at least one radio network node, beam-based PRS associated with the determined set of transmitter beams; and
measure Time Of Arrival, TOA, of the beam-based associated with the determined set of transmitter beams.

48. The target device according to claim 47, wherein the memory circuitry storing computer program code which, when run in the processing circuitry, causes the target device to:
combine, based on the received list of transmitter beam IDs accompanied with corresponding PRS configurations, two or more of the measured TOAs into one TOA.

49. The target device according to claim 47, wherein the memory circuitry storing computer program code which, when run in the processing circuitry, causes the target device to:
transmit, to the location server or to at least one radio network node, a report based on the measured TOAs of the beam-based PRSs.

50. The target device according to claim 47, wherein the memory circuitry storing computer program code which, when run in the processing circuitry, further causes the target device to:
receive, from the location server, a capability request associated with positioning to indicate type of capabilities associated with beam-based measurements supported by the target device; and in response thereto
transmit, to the location server, a capability response indicating measurement configurations supported by the target device in relation to beam-based measurements.

51. The target device according to claim 47, wherein the memory circuitry storing computer program code which, when run in the processing circuitry, further causes the target device to determine a set of transmitter beams for subsequent measuring by:
determine resources associated with the transmitter beams during which beam-based PRS may be transmitted via corresponding beams.

52. The target device according to claim 47, wherein the memory circuitry storing computer program code which, when run in the processing circuitry, further causes the target device to:
determine at least one radio signal sequence associated with a transmitter beam to be used for a positioning measurement and determine the numerology of the signal.

53. The target device according to claim 47, wherein the memory circuitry storing computer program code which, when run in the processing circuitry, further causes the target device to:
determine, and configure, a receiver beam ID to receive the beam-based PRS associated with a corresponding transmitter beam ID.

54. The target device according to claim 47, wherein the memory circuitry storing computer program code which, when run in the processing circuitry, further causes the target device to:
perform self-localization based on the measured TOAs of the beam-based PRSs and known positions of the radio network nodes transmitting the corresponding beam-based PRSs, by using multilateral techniques.

55. A method, implemented in a location server for performing beam-based positioning, the method comprising:
determining, based on a Beam Reference Signal (BRS) Received Power (RP) report from a target device, a list of transmitter beam Identities (IDs) for one or more radio cells associated with one or more radio network nodes;
determining resources for beam-based Positioning Reference Signal (PRS) for each radio network node based on the radio network node's common and beam specific parameters; and
transmitting, to the target device, a list of transmitter beam IDs, accompanied with corresponding beam-based PRS configurations for the one or more radio cells associated with one or more radio network nodes, wherein different beam-based PRS sequences are used for different transmitter beams of one radio network node.

56. The method according to claim 55, wherein the method further comprises:
transmitting resources for beam-based PRS to each of the radio network nodes.

57. The method according to claim 55, wherein the method further comprises:
receiving, from the target device, a report based on measured TOAs of the beam-based PRSs; and
computing a position of the target device, based on the received report and known positions of the radio network nodes transmitting the corresponding beam-based PRSs, by using multilateral techniques.

58. A location server configured to performing beam-based positioning, the location server comprises:
processing circuitry; and
memory circuitry storing computer program code which, when run in the processing circuitry, causes the location server to:
determine, based on a Beam Reference Signal (BRS) Received Power (RP) report from a target device, a list of transmitter beam Identities (IDs) for one or more radio cells associated with one or more radio network nodes;
determine resources for beam-based Positioning Reference Signal (PRS) for each radio network node based on the radio network node's common and beam specific parameters; and
transmit, to the target device, a list of transmitter beam IDs accompanied with corresponding beam-based PRS configurations for the one or more radio cells associated with one or more radio network nodes, wherein different beam-based PRS sequences are used for different beams of one radio network node.

59. The location server according to claim 58, the memory circuitry storing computer program code which, when run in the processing circuitry, further causes the location server to:
transmit resources for beam-based PRS to each of the radio network nodes.

60. The location server according to claim 58, the memory circuitry storing computer program code which, when run in the processing circuitry, further causes the location server to:
receive, from the target device, a report based on measured TOAs of the beam-based PRSs; and
compute a position of the target device, based on the received report and known positions of the radio network nodes transmitting the corresponding beam-based PRSs, by using multilateral techniques.

61. A method, implemented in a radio network node for performing beam-based positioning, the method comprising:
transmitting, to a target device, a beam-based Positioning Reference Signal (PRS), wherein different beam-based PRS sequences are used for different transmitter beams of the radio network node.

62. The method according to claim 61, wherein the method further comprises:
receiving, from a target device, a report based on measured TOAs of the beam-based PRSs; and
computing a position of the target device, based on the received report and known positions of the radio network nodes transmitting the corresponding beam-based PRSs, by using multilateral techniques.

63. A radio network node configured to performing beam-based positioning, the radio network node comprises:
processing circuitry; and
memory circuitry storing computer program code which, when run in the processing circuitry, causes the radio network node to: transmit, to a target device, a beam-based Positioning Reference Signal (PRS), wherein different beam-based PRS sequences are used for different transmitter beams of the radio network node.

64. The radio network node according to claim 63, wherein the memory circuitry storing computer program code which, when run in the processing circuitry, further causes the radio network node to:
receive, from a target device, a report, based on measured TOAs of the beam-based PRSs; and
compute a position of the target device based on the received report and known positions of the radio network nodes transmitting the corresponding beam-based PRSs, by using multilateral techniques.
